(19) United States
(12) Patent Application Publication
(10) Pub. No.: US 2024/0067096 A1
(43) Pub. Date: Feb. 29, 2024

(54) CONSOLE BOX AND INTERIOR STRUCTURE FOR VEHICLE

(71) Applicant: TOYODA GOSEI CO., LTD., Kiyosu-shi (JP)

(72) Inventors: Naoyuki FUKUI, Kiyosu-shi (JP); Yu HISHIDA, Kiyosu-shi (JP); Takuto KAMAYA, Kiyosu-shi (JP)

(21) Appl. No.: 18/453,469

(22) Filed: Aug. 22, 2023

(30) Foreign Application Priority Data
Aug. 31, 2022 (JP) 2022-137458
Aug. 31, 2022 (JP) 2022-137459
Aug. 31, 2022 (JP) 2022-137460
Aug. 31, 2022 (JP) 2022-137461

(51) Int. Cl. B60R 7/04

(52) U.S. Cl. CPC B60R 7/04

(57) ABSTRACT

A console box includes a box body including a storage that has an upper opening and a lid detachably coupled to the box body and configured to open and close the upper opening. The lid includes an additional function portion that allows a user to use the lid in a manner that is different from the opening and closing of the upper opening.

### BACKGROUND

### 1. Field

The present disclosure relates to a console box and an interior structure for a vehicle.

### 2. Description of Related Art

Japanese Laid-Open Patent Publication No. 2020-82926 discloses a known double-door console box. Such a console box includes a substantially box-shaped box body, a lid, and an opening-closing mechanism. The box body includes a storage having an opening on its upper surface. The lid opens and closes the opening of the storage. The opening-closing mechanism opens and closes the lid to pivot about one of the left and right pivot shafts. Such a console box is a part of an interior structure for a vehicle.

Recently, with diversification of customer needs, it has been desired to add new functions to a console box and an interior structure for a vehicle that includes a console box. For example, the lid may be configured to be detachable from the box body and a function corresponding to the above needs may be added to the lid. However, such a console box has not been provided. In addition, the lid may be configured to be detachable from the box body and a function corresponding to the above needs may be enabled using the lid. However, such an interior structure for a vehicle has not been provided.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A console box according to an aspect of the present disclosure includes a box body including a storage that has an upper opening; and a lid detachably coupled to the box body and configured to open and close the upper opening. The lid includes an additional function portion that allows a user to use the lid in a manner that is different from the opening and closing of the upper opening.

A vehicle interior structure according to an aspect of the present disclosure includes an interior structure for a vehicle. The interior structure includes a console box including a box body with a storage that has an upper opening and including a lid detachably coupled to the box body and configured to open and close the upper opening, and a vehicle interior component configured to be detachably coupled to the lid that has been detached from the box body, the vehicle interior component being different from the console box. The lid includes a function portion that functions when the lid is coupled to the vehicle interior component.

Other features and aspects will be apparent from the following detailed description, the drawings, and the claims.

### BRIEF DESCRIPTION OF DRAWINGS

FIG. 1 is a perspective view showing the main section of a console box in a first embodiment.

FIG. 2 is a perspective view showing the box portion in the first embodiment.

FIG. 3 is an exploded perspective view showing a support, shims, and second springs in the first embodiment.

FIG. 4 is a partially exploded perspective view showing the front part of the support, the shim, and the second spring in the first embodiment.

FIG. 5 is a partially exploded perspective view showing the rear part of the support, the shim, and the second spring in the first embodiment.

FIG. 6 is an exploded perspective view showing the lid in the first embodiment.

FIG. 7 is a partially exploded perspective view showing the lid in the first embodiment.

FIG. 8 is a partial vertical cross-sectional view showing the upper part of the console box in the first embodiment.

FIG. 9 is a partial cross-sectional view showing the upper part of the console box taken along line 9-9 in FIG. 8.

FIG. 10 is a partial cross-sectional view that corresponds to FIG. 9, showing the upper part of the console box in which the operation portion has been pushed.

FIG. 11 is a partial cross-sectional view showing the upper part of the console box taken along line 11-11 in FIG. 8.

FIG. 12 is a partial cross-sectional view showing the upper part of the console box taken along line 12-12 in FIG. 8.

FIG. 13 is a schematic perspective view of the lid in the first embodiment as viewed from the second surface, showing a state in which each leg is located at its fold position.

FIG. 14 is a schematic perspective view showing a state in which each leg is located at its use position in FIG. 13.

FIG. 15 is a schematic perspective view showing a state in which the legs are attached to the lid in a modification.

FIG. 16 is a schematic perspective view showing a state in which the legs are attached to the lid in another modification.

FIG. 17 is a perspective view showing the main section of the console box in a second embodiment.

FIG. 18 is an exploded perspective view showing the lid in the second embodiment.

FIG. 19 is a partially exploded perspective view showing the lid in the second embodiment.

FIG. 20 is a partial vertical cross-sectional view showing the upper part of the console box in the second embodiment.

FIG. 21 is a partial cross-sectional view showing the upper part of the console box taken along line 21-21 in FIG. 20.

FIG. 22 is a partial cross-sectional view that corresponds to FIG. 21, showing the upper part of the console box in which the operation portion has been pushed.

FIG. 23 is a partial cross-sectional view showing the upper part of the console box taken along line 23-23 in FIG. 20.

FIG. 24 is a partial cross-sectional view showing the upper part of the console box taken along line 24-24 in FIG. 20.

FIG. 25 is a schematic perspective view of the lid in the second embodiment as viewed from the second surface, showing a state in which the door is located at a second position.

FIG. 26 is a schematic perspective view showing a state in which the door is located at a first position in FIG. 25.

FIG. 27 is a perspective view showing the main section of the console box in a third embodiment.

FIG. 28 is an exploded perspective view showing the lid in the third embodiment.

FIG. 29 is a partial exploded perspective view showing the lid in the third embodiment.

FIG. 30 is a partial vertical cross-sectional view showing the upper part of the console box in the third embodiment.

FIG. 31 is a partial cross-sectional view showing the upper part of the console box taken along line 31-31 in FIG. 30.

FIG. 32 is a partial cross-sectional view that corresponds to FIG. 31, showing the upper part of the console box in which the operation portion has been pushed.

FIG. 33 is a partial cross-sectional view showing the upper part of the console box taken along line 33-33 in FIG. 30.

FIG. 34 is a partial cross-sectional view showing the upper part of the console box taken along line 34-34 in FIG. 30.

FIG. 35 is a block diagram showing the configuration of a power supply system in the third embodiment.

FIG. 36 is a perspective view of the lid, showing a state in which a portable terminal is placed on the second surface of the lid that has been removed from the box body to supply power to the mobile terminal in a contactless manner in the third embodiment.

FIG. 37 is a partial cross-sectional view of the lid, showing the state in which a portable terminal is placed on the second surface of the lid that has been removed from the box body to supply power to the mobile terminal in a contactless manner in the third embodiment.

FIG. 38 is a perspective view showing the lid in which a speaker is incorporated in addition to the battery in a fourth embodiment.

FIG. 39 is a block diagram showing the configuration of the power supply system in the fourth embodiment.

FIG. 40 is an exploded perspective view showing a modification of the lid in which warmers are incorporated as the electronic devices, together with a boxed meal to be kept warm.

FIG. 41 is an exploded perspective view showing the modification of the lid in which coolers are incorporated as the electronic devices, together with beverage containers to be kept cool.

FIG. 42 is a perspective view showing the main section of the console box included in an interior structure for a vehicle in an embodiment.

FIG. 43 is an exploded perspective view showing the lid of the console box in FIG. 42.

FIG. 44 is a partial exploded perspective view showing the lid of the console box in FIG. 42.

FIG. 45 is a partial vertical cross-sectional view showing the upper part of the console box in FIG. 42

FIG. 46 is a partial cross-sectional view showing the upper part of the console box taken along line 46-46 in FIG. 45.

FIG. 47 is a partial cross-sectional view that corresponds to FIG. 46, showing the upper part of the console box in FIG. 42 in which the operation portion has been pushed.

FIG. 48 is a partial cross-sectional view showing the upper part of the console box taken along line 48-48 in FIG. 45.

FIG. 49 is a partial cross-sectional view showing the upper part of the console box taken along line 49-49 in FIG. 45.

FIG. 50 is a schematic perspective view showing the lid of the console box of FIG. 42 as viewed from the second surface.

FIG. 51 is a schematic perspective view showing the lid of the console box in FIG. 42, the lid being coupled to a door trim.

FIG. 52 is a schematic perspective view of the interior structure for the vehicle in a modification, showing a state in which the lid is coupled to an instrument panel.

FIG. 53 is a schematic perspective view of the interior structure for the vehicle in another modification, showing a state in which the lid is coupled to a roof lining.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

In the following description, the direction in which a vehicle advances forward will be referred to as the front, and the reverse direction will be referred to as the rear. The up-down direction refers to the up-down direction of the vehicle, and the left-right direction refers to the width direction of the vehicle that coincides with the left-right direction when the vehicle is traveling forward.

To specify the position of the console box in each of the front-rear direction, the up-down direction, and the left-right direction, a central portion of the console box in each direction is used as a reference. Among the respective directions, a direction, a side, or the like closer to the central portion is referred to as “inside”, “inward”, “inner side”, or the like, and a direction, a side, or the like farther from the central portion is referred to as “outside”, “outward”, “outer side”, or the like.

Console Box

First to fourth embodiments of the console box will now be described with reference to the drawings.

### First Embodiment

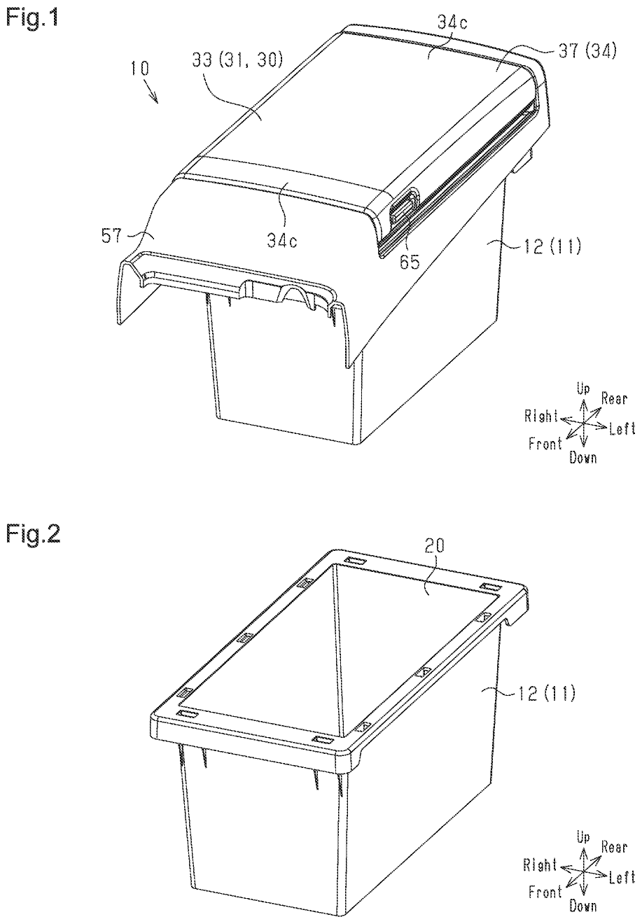

A console box 10 according to a first embodiment will now be described with reference to FIGS. 1 to 14.

Console Box 10

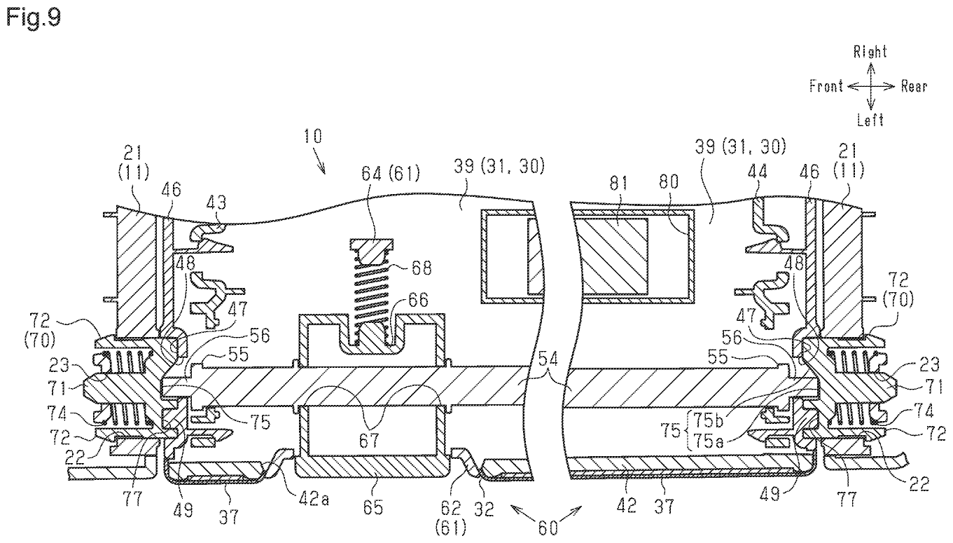

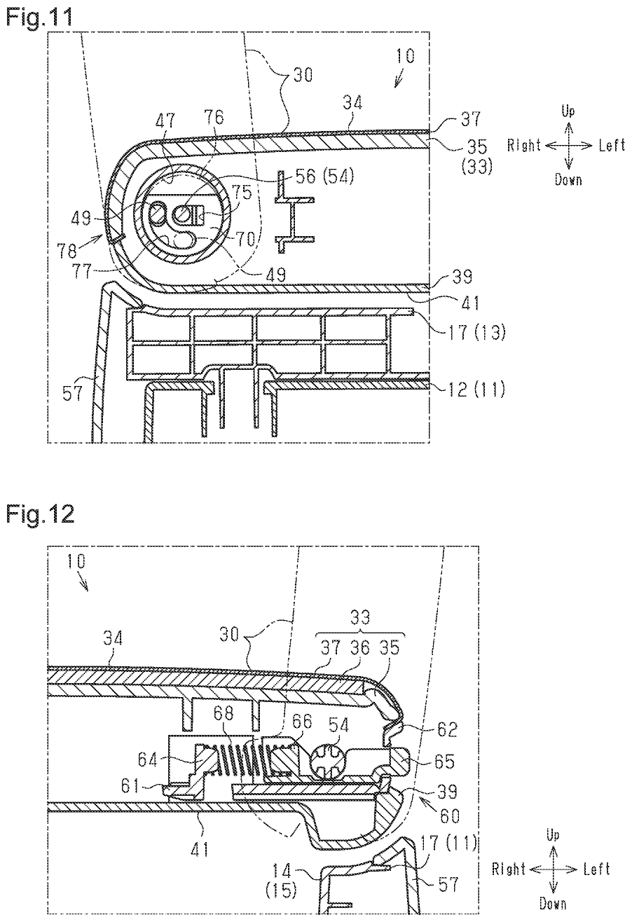

FIG. 1 shows the main section of the console box 10. The console box 10 is a part of a center console disposed between the driver's seat and the passenger seat in a passenger compartment. The console box 10 includes a box body 11, a lid 30, a housing 57, a lock mechanism 60 (see FIG. 9), and a pivot range defining portion 78 (see FIG. 11). Next, each component of the console box 10 will be described.

Box Body 11

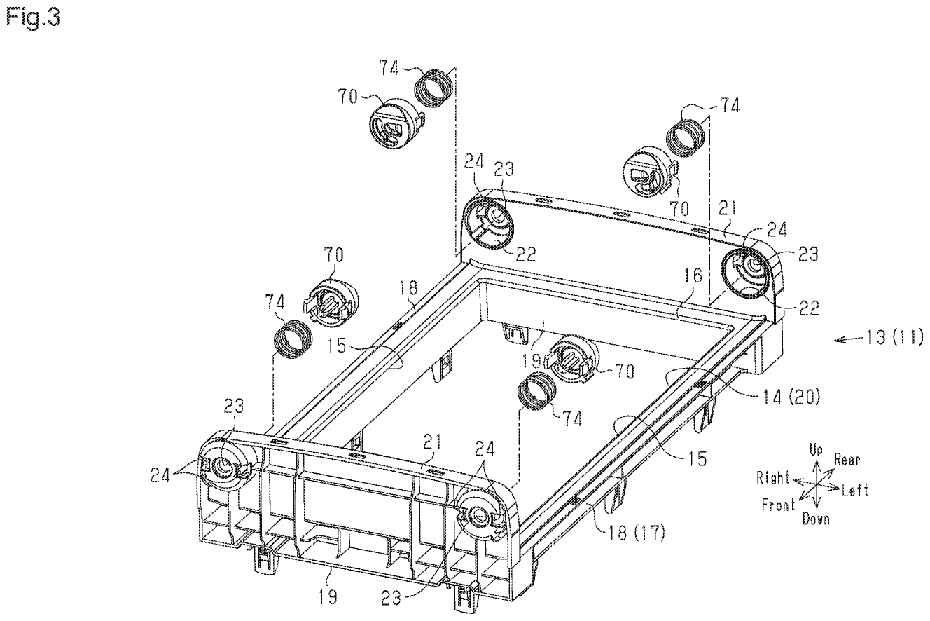

As shown in FIGS. 2 and 3, the box body 11 includes a box portion 12 having an open upper end and a closed end, and a support 13 disposed on the upper side of the box portion 12. The box portion 12 has a substantially rectangular parallelepiped shape that is longer in the front-rear direction than in the left-right direction.

The support 13 has a structure symmetrical in the front-rear direction and a structure symmetrical in the left-right direction. Thus, the structure of the support 13 on one side in the front-rear direction will be hereinafter described, and the structure of the support 13 on the other side will not be described. Further, the structure of the support 13 on one side in the left-right direction will be hereinafter described, and the structure of the support 13 on the other side will not be described. The same applies not only to the support 13 but also to the other members of the console box 10.

The lower part of the support 13 is defined by a rectangular frame 17. The space surrounded by the frame 17 and the internal space of the box portion 12 define a storage 20 that stores an item (e.g., a small item). The space in the storage 20 surrounded by the frame 17 is an upper opening 14 of the storage 20. The upper opening 14 is rectangular in plan view. The upper opening 14 has two first sides 15 facing each other in the left-right direction and two second sides 16 facing each other in the front-rear direction (only one side is shown in FIG. 3). The first sides 15 and the second sides 16 are orthogonal to each other, respectively.

As shown in FIG. 3, the frame 17 includes two first walls 18 extending in the front-rear direction while being spaced apart from each other in parallel in the left-right direction, and two second walls 19 extending in the left-right direction while being spaced apart from each other in parallel in the front-rear direction. The ends of the front second wall 19 in the left-right direction are coupled to the front ends of the first walls 18, respectively. The ends of the rear second wall 19 in the left-right direction are coupled to the rear ends of the first walls 18, respectively. The first wall 18 has a corresponding first side 15. The second wall 19 has a corresponding second side 16.

Support walls 21 extend upward from the front and rear second walls 19, respectively. Shim accommodating portions 22 are opened in the inner surface of each support wall 21 in the front-rear direction. The shim accommodating portions 22 are located on the opposite side portions of each support wall 21 in the left-right direction.

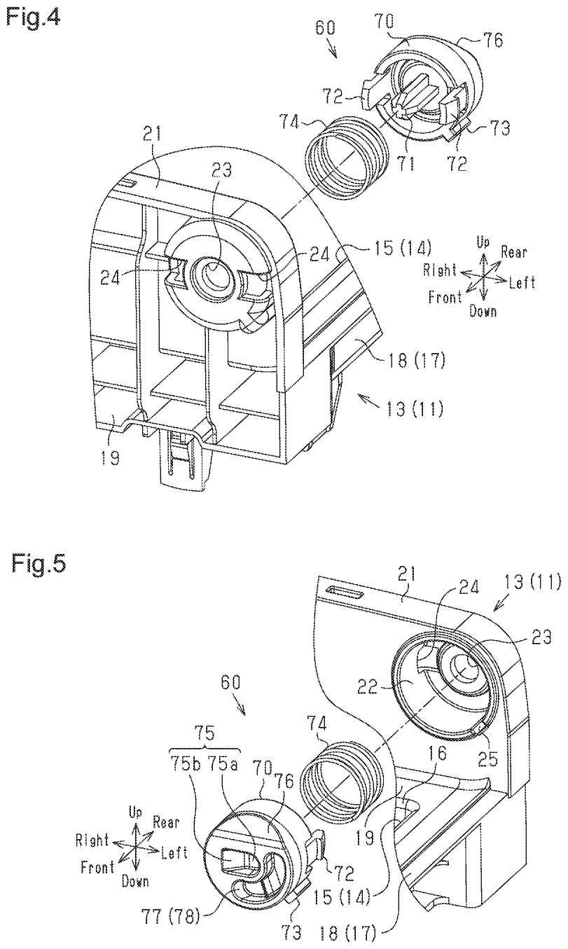

As shown in FIGS. 4 and 5, each of the shim accommodating portions 22 has a cylindrical shape extending in the front-rear direction. Each of the shim accommodating portions 22 includes an insertion hole 23, two engagement holes 24, and a rotation restricting groove 25. The insertion hole 23 of each shim accommodating portion 22 extends through a central portion of the bottom of the shim accommodating portion 22. The two engagement holes 24 of each shim accommodating portion 22 are located on the opposite side portions of the insertion hole 23 of the shim accommodating portion 22 in the left-right direction. The rotation restricting groove 25 extends in the front-rear direction and protrudes radially outward from a part of the outer circumferential portion of the shim accommodating portion 22.

Lid 30

Referring to FIG. 1, the lid 30 is detachably coupled to the box body 11. In a state in which the lid 30 is coupled to the box body 11, the lid 30 can be pivoted between a closed position at which the lid 30 closes the upper opening 14 as indicated by the solid line in FIG. 12 and a fully-open position at which the lid 30 is raised to fully open the upper opening 14 as indicated by the long dashed double-short dashed line in FIG. 12. In other words, the lid 30 opens and closes the upper opening 14 by pivoting between the closed position and the fully-open position. Thus, the lid 30 with the upper opening 14 closed will hereinafter be described.

Basic Structure of Lid 30

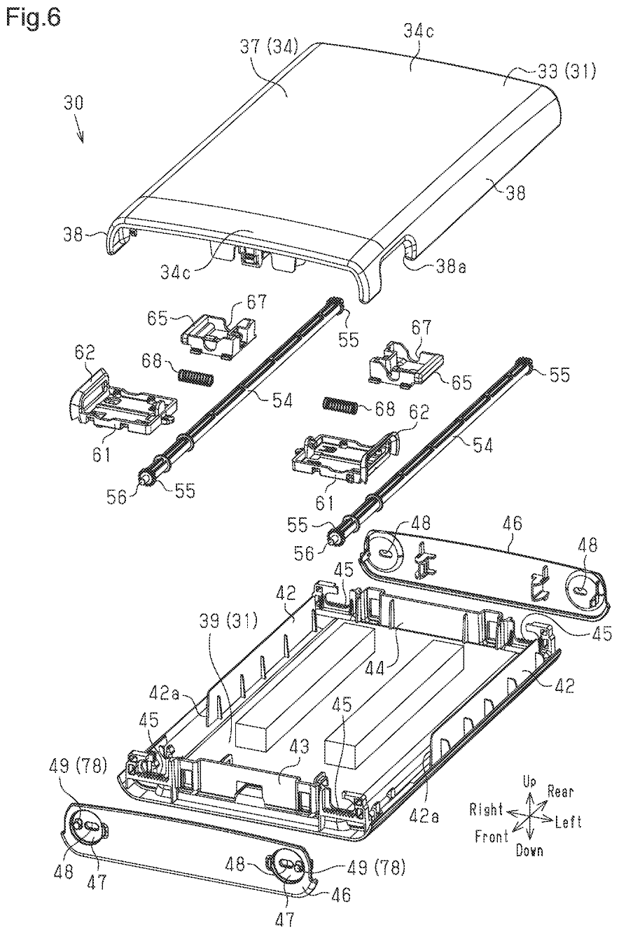

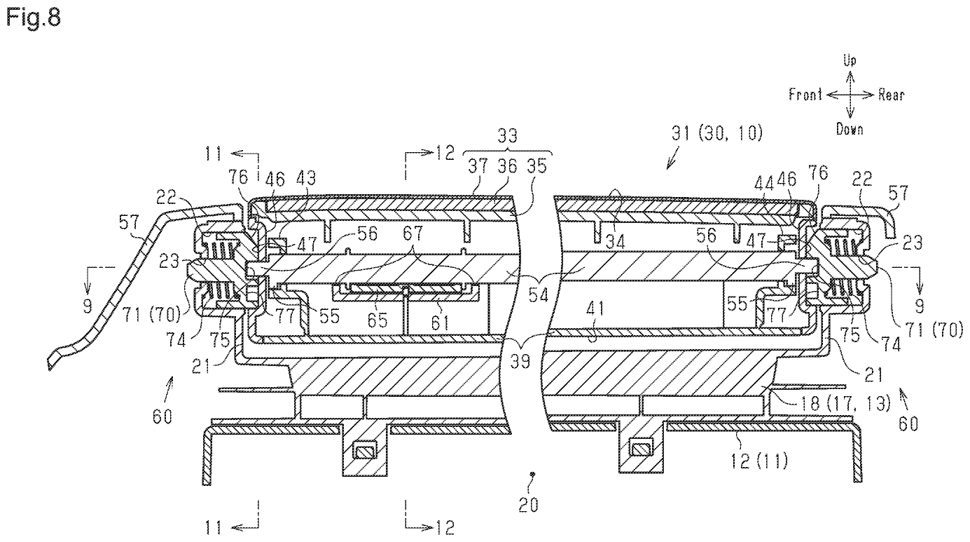

As shown in FIG. 6, the lid 30 includes a lid body 31, two support plates 46, and two pivot shafts 54. The lid body 31 is shaped and sized so as to close the upper opening 14 (see FIG. 3) from above. The up-down direction of the lid body 31 is the thickness direction of the lid body 31. The lid body 31 includes a first halved body 33 located on one side in the thickness direction and a second halved body 39 located on the other side and joined to the first halved body 33. FIG. 8 illustrates the lid 30 with the first halved body 33 located above the second halved body 39.

As shown in FIG. 8, the first halved body 33 includes a base 35 formed of a hard resin material, a cushion layer 36 laminated on the base 35 and formed of a foam, and a covering 37 laminated on the cushion layer 36. The portion of the covering 37 that is a surface of the lid 30 on one side in the thickness direction is a first surface 34 of the lid 30. That is, the first surface 34, which is one of the surfaces of the lid 30 in the thickness direction, is defined by the covering 37. At least a part of the first surface 34 of the lid 30 has an armrest surface. In the present embodiment, the entire first surface 34 is the armrest surface.

The entire second halved body 39 is formed of a hard resin material. The surface of the second halved body 39 on the opposite side (back side) to the first surface 34 in the thickness direction is a second surface 41 of the lid 30.

As shown in FIG. 6, the first halved body 33 includes two side walls 38 in the left-right direction, and the front part of each side wall 38 has a notch 38a. Similarly, the second halved body 39 includes two side walls 42 in the left-right direction, and the front part of each side wall 42 has a notch 42a. When the second halved body 39 is joined to the first halved body 33, the notches 38a, 42a form an operation hole 32 as shown in FIG. 9.

As shown in FIG. 6, the two support plates 46 are disposed on the opposite outer sides of the lid body 31 in the front-rear direction, respectively. The front support plate 46 is attached to a front wall 43 of the second halved body 39. The rear support plate 46 is attached to a rear wall 44 of the second halved body 39. The outer surface of each support plate 46 in the front-rear direction is a part of a side surface of the lid 30.

As shown in FIG. 8, the box body 11 and the lid 30 are shaped such that the lid 30 is detachable from and couplable to the box body 11 regardless of whether the first surface 34 or the second surface 41 of the lid 30 is oriented upward.

The two pivot shafts 54 function to pivotally couple the lid body 31 to the box body 11. As shown in FIG. 6, the two pivot shafts 54 extend in the front-rear direction in parallel with each other on the opposite side portions of the lid body 31 in the left-right direction. The lid 30 is pivotable between the closed position and the fully-open position about one pivot shaft 54 selected from the two pivot shafts 54.

Pinion gears 55 are respectively disposed on the outer circumferences of the opposite ends of each pivot shaft 54 in the front-rear direction. Rack gears 45 are respectively disposed on the opposite side portions of each of the front wall 43 and the rear wall 44 of the second halved body 39 in the left-right direction. The pinion gear 55 at the front end of each pivot shaft 54 is meshed with the rack gear 45 of the front wall 43, and the pinion gear 55 at the rear end of each pivot shaft 54 is meshed with the rack gear 45 of the rear wall 44.

Each pivot shaft 54 includes a pin 56 that extends in the front-rear direction on the outer side of the pinion gear 55 in the front-rear direction. Recesses 47 recessed inward in the front-rear direction are respectively disposed at the left and right side portions of each of the front and rear support plates 46. The bottom of each recess 47 has an elongated hole 48 that extends through the support plate 46 in the left-right direction. The pin 56 of each pivot shaft 54 is inserted through a corresponding elongated hole 48.

The lid 30 can pivot integrally with any one of the pivot shafts 54. The pinion gear 55 can roll on the rack gear 45. Each elongated hole 48 allows the pin 56 to move in the left-right direction, and defines the range of movement of the pin 56 in the left-right direction.

Housing 57

As shown in FIGS. 1 and 8, a housing 57 accommodates the box body 11 with the upper surface and the side surface of the lid 30 exposed. FIG. 1 shows only a part of the housing 57.

Lock Mechanism 60

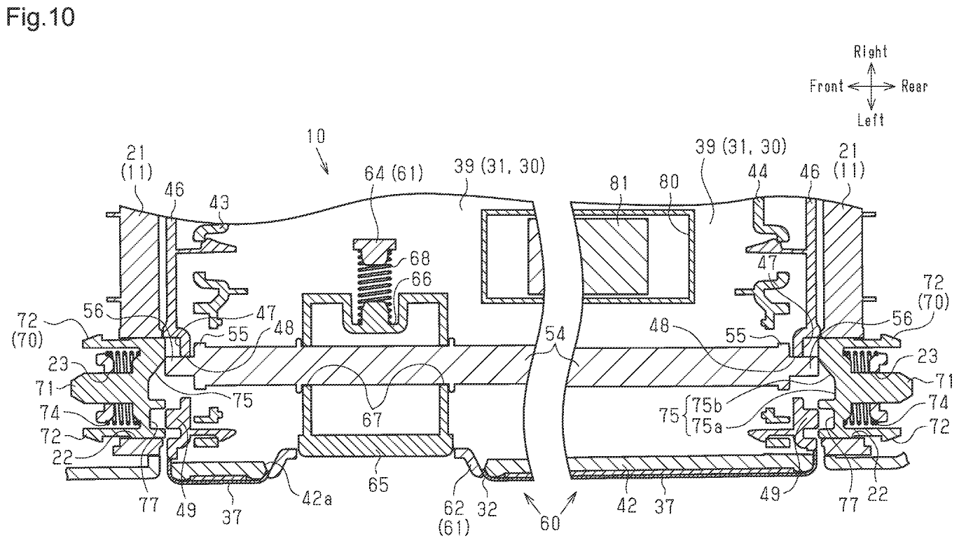

As shown in FIGS. 9 and 10, the lock mechanism 60 functions to lock the lid 30 in a state in which the upper opening 14 is closed (i.e., lock the lid 30 at the closed position) and unlock the lid 30. The lock mechanism 60 also functions to switch between a coupled state in which each pivot shaft 54 is coupled to the box body 11 and a state in which they are decoupled from each other.

The unlocked state includes the following two states.

A state in which the left and right pivot shafts 54 are decoupled from the box body 11

A state in which one of the pivot shafts 54 remains coupled to the box body 11 and the other pivot shaft 54 is decoupled from the box body 11.

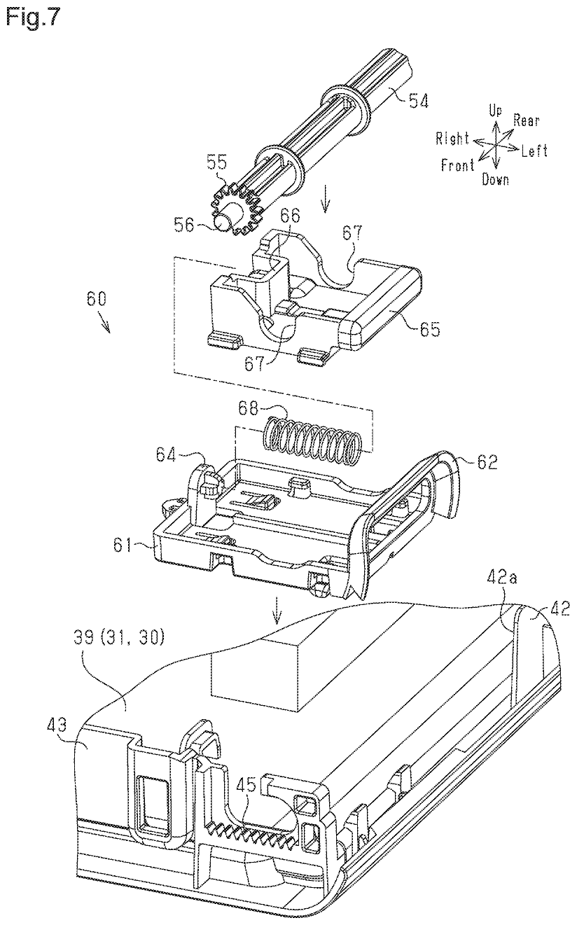

As shown in FIGS. 7 to 9, at the front part of the lid 30, operation bases 61 are respectively attached to the opposite side portions of the lid 30 in the left-right direction. The outer portion of each of the left and right operation bases 61 in the left-right direction has an entrance 62, which has the form of a gate. The entrance 62 of each operation base 61 is located in the operation hole 32 of the lid body 31. The inner side portion of each operation base 61 in the left-right direction has a spring receiving portion 64.

An operation portion 65 is disposed on each operation base 61 to be slidable in the left-right direction through the entrance 62. The left and right operation portions 65 (two operation portions 65) are included in the lid 30 as members of the lock mechanism 60. The left and right operation portions 65 are provided independently of each other to respectively correspond to the left and right pivot shafts 54 (two pivot shafts 54).

The inner side portion of each operation portion 65 in the left-right direction has a spring receiving portion 66 at a position facing the spring receiving portion 64. A first spring 68 is disposed in a state of being compressed in the left-right direction between the two spring receiving portions 64, 66.

Each operation portion 65 is constantly biased outward in the left-right direction by a corresponding first spring 68. The opposite side portion of each operation portion 65 in the front-rear direction respectively have arcuate bearings 67. The top of each bearing 67 is open. Each pivot shaft 54 is supported by the two bearings 67 to be pivotable about the operation portion 65.

While a coil spring is used as the first spring 68 in the present embodiment, another type of spring may be used. The same applies to a second spring 74, which will be described later.

As shown in FIGS. 4, 5, 8, and 9, shims 70 are respectively accommodated in the left and right shim accommodating portions 22 of each support wall 21. Each of the shims 70 is coupled to the support wall 21 to be movable in the front-rear direction and restricted from rotating. Each shim 70 functions to detachably couple the end of a corresponding pivot shaft 54 to the box body 11. Each shim 70 functions to pivotally support a corresponding pivot shaft 54 in a state in which the end of the pivot shaft 54 is coupled to the box body 11.

Each shim 70 is cylindrical, and has an outer portion that is opened in the front-rear direction Each shim 70 includes a shaft 71 extending in the front-rear direction, two engagement portions 72, and a rotation restricting protrusion 73. The shaft 71 of each shim 70 is located at a central portion of the shim 70, and is inserted into the insertion hole 23 of a corresponding shim accommodating portion 22 to be movable in the front-rear direction.

The two engagement portions 72 of each shim 70 are located on the left and right sides of the shaft 71 in the shim 70, and are inserted into the engagement holes 24 of a corresponding shim accommodating portion 22 to be movable in the front-rear direction. The rotation restricting protrusion 73 of each shim 70 protrudes radially outward from a part of the outer circumference of the shim 70, and is engaged with the rotation restricting groove 25 of a corresponding shim accommodating portion 22 to be movable in the front-rear direction.

Each shim 70 is movable in the front-rear direction between a coupling position at which the shim 70 is in contact with the bottom of the recess 47 in the support plate 46 as shown in FIG. 9 and a detaching position at which the shim 70 is spaced outward from the coupling position in the front-rear direction as shown in FIG. 10.

The shaft 71, the two engagement portions 72, and the rotation restricting protrusion 73 of each shim 70 function to guide the movement of the shim 70 in the front-rear direction. Further, the two engagement portions 72 function to restrict the shim 70 from falling off from the shim accommodating portion 22 inward in the front-rear direction. This function is provided when each engagement portion 72 is engaged with a peripheral portion of a corresponding engagement hole 24 in the shim accommodating portion 22.

The second spring 74 is disposed between the shim 70 and the inner bottom surface of each of the shim accommodating portions 22 of the front and rear support walls 21 in a state of being compressed in the front-rear direction. Each shim 70 is constantly biased inward in the front-rear direction by the second spring 74.

As shown in FIGS. 4, 5, 8, and 9, each shim 70 includes an accommodating recess 75 with a reference surface 75a and an inner inclined surface 75b, and includes an outer inclined surface 76. The accommodating recess 75 of each shim 70 is open on its inner surface in the front-rear direction. The reference surface 75a of each accommodating recess 75 is located at the central portion of the shim 70 and is orthogonal to the axis of the shim 70. The inner inclined surface 75b of each accommodating recess 75 is located inward of the reference surface 75a in the left-right direction and is connected to the reference surface 75a. Each inner inclined surface 75b is inclined with respect to the reference surface 75a such that its inner side in the front-rear direction becomes closer to its inner side in the left-right direction.

The outer inclined surface 76 of each shim 70 is located on the upper part of the inner surface of the shim 70 in the front-rear direction. Each outer inclined surface 76 is inclined with respect to the vertical plane such that its inner side in the front-rear direction becomes closer to its lower side.

Pivot Range Defining Portion 78

The pivot range defining portion 78 defines a pivot range of the lid 30 such that the lid 30 pivots between the closed position and the fully-open position, which have been described above. As shown in FIGS. 5, 6, and 11, the pivot range defining portion 78 includes four (only two on the front side are shown in FIG. 6) protrusions 49 of the lid 30 and grooves 77 of the shims 70.

Specifically, each protrusion 49 protrudes outward in the front-rear direction from a position outside the elongated hole 48 in the left-right direction of the front and rear support plates 46. Each protrusion 49 turns around the pivot shaft 54 as the lid 30 pivots.

Each groove 77 has an arc shape centered on the reference surface 75a of the accommodating recess 75. Each groove 77 is open on the inner surface of the shim 70 in the front-rear direction. Each protrusion 49 is inserted into a corresponding groove 77. Each protrusion 49 is circumferentially movable along the groove 77. Each groove 77 is formed such that the lid 30 is located at the closed position when the protrusion 49 moves to one end of the groove 77 in the circumferential direction and the lid 30 is located at the fully-open position when the protrusion 49 moves to the other end.

Configuration of Lid 30 on Second Surface 41

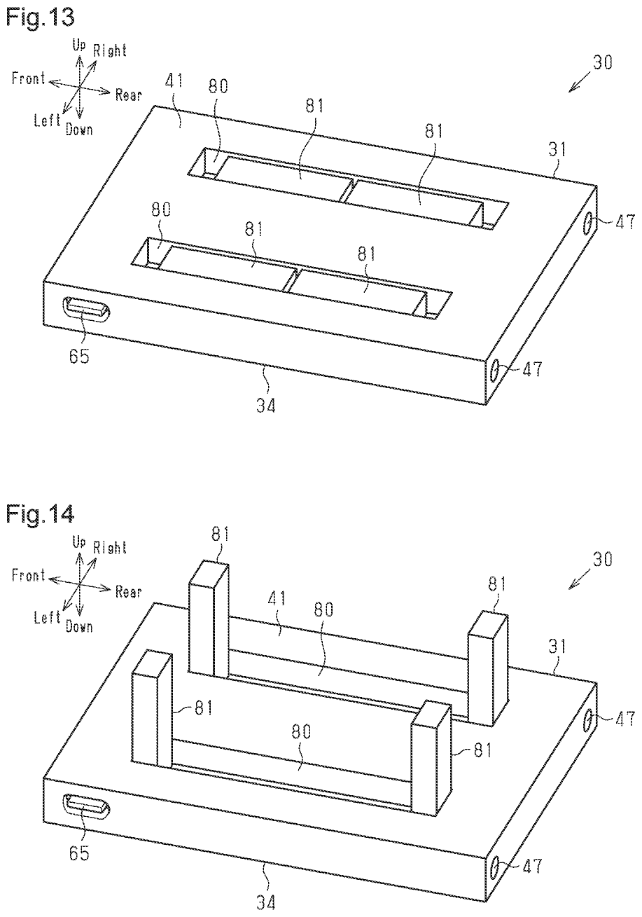

As shown in FIG. 13, the second surface 41, which is one surface of the lid body 31 of the lid 30 in the thickness direction, includes two rectangular storage recesses 80 that extend in the front-rear direction. The storage recesses 80 are arranged in parallel and spaced apart from each other in the left-right direction. The two storage recesses 80 face each other with the central portion of the second surface 41 located in between in the left-right direction. Each storage recess 80 stores two quadrangular prism-shaped legs 81 extending in the front-rear direction. As will be described later, each leg 81 functions as an additional function portion that enables a user to use the lid 30 in a manner different from the opening and closing of the upper opening 14.

The two legs 81 are arranged side by side in the front-rear direction in each storage recess 80. The rear end of the leg 81 on the rear side of each of the two legs 81 is coupled to the rear end of a corresponding storage recess 80 to be pivotable about an axis extending in the left-right direction. The front end of the leg 81 on the front side of each of the two legs 81 is coupled to the front end of a corresponding storage recess 80 to be pivotable about an axis extending in the left-right direction.

Thus, the legs 81 are disposed on the second surface 41, which is one surface of the lid body 31 in the thickness direction. That is, the second surface 41 of the lid body 31 is a surface of the lid body 31 where the legs 81 are disposed. The first surface 34 of the lid body 31 is a surface of the lid body 31 opposite to the legs 81.

As shown in FIGS. 13 and 14, each leg 81 is configured to be pivoted (moved) between a use position (shown in FIG. 14) at which the leg 81 is raised from the lid body 31 and a fold position (shown in FIG. 13) at which the leg 81 is folded. The angle between the use position and the fold position of each leg 81 is a right angle.

When each leg 81 is located at the fold position, the leg 81 is stored in the storage recess 80 in a state of extending in the front-rear direction. That is, when pivoted (moved) to the fold position, the legs 81 are stored in the storage recess 80. At the use position, each leg 81 extends in the up-down direction, which is orthogonal to the second surface 41, at the front or rear end of the storage recess 80. When the position of the lid 30 is changed, each leg 81 is configured not to be pivoted by its weight through a frictional force produced between the leg 81 and the storage recess 80.

In the lid body 31, the second surface 41 is formed of a hard resin material, and the first surface 34 is defined by the covering 37. That is, in the lid body 31, the first surface 34 is made of a material softer than that of the second surface 41.

Next, the operation of the console box 10 will be described.

When None of Operation Portions 65 is Pushed

As indicated by the solid lines in FIGS. 9 and 12, when the lid 30 is located at the closed position and none of the operation portions 65 is pushed, the outer portions of the left and right operation portions 65 in the left-right direction protrude from the entrance 62. In this case, each shim 70 biased inward in the front-rear direction by the second spring 74 is in contact with the bottom of the recess 47 of the support plate 46 and is held at the coupling position.

The biasing force of the first spring 68 biasing each operation portion 65 outward in the left-right direction is transmitted to the pivot shaft 54 through the operation portion 65. The front and rear pins 56 of each pivot shaft 54 are in contact with the reference surface 75a of the accommodating recess 75. Each pin 56 is located at the outer end of the elongated hole 48 in the left-right direction.

The pinion gear 55 of each pivot shaft 54 is meshed with the outer portion of a corresponding rack gear 45 in the left-right direction. The left and right pivot shafts 54 are coupled to the front and rear support walls 21 by the front and rear shims 70. Thus, since the lid 30 is locked at the closed position, the upper opening 14 is held in the closed state.

In this state, if an article is stored in the storage 20, the lid 30 keeps the article stored.

In addition, the box body 11 and the lid 30 are shaped such that the lid 30 is detachable from and couplable to the box body 11 regardless of whether the first surface 34 or the second surface 41 is oriented upward.

Thus, if the lid 30 is moved such that the first surface 34 faces upward as shown in FIG. 12, the first surface 34 may function as a section on which an elbow is placed. In other words, the lid 30 may function as an armrest.

When One Operation Portion 65 is Pushed

As shown in FIG. 10, when one of the two operation portions 65 is pressed inward in the left-right direction against the biasing force of the first spring 68, a force is applied to the pivot shaft 54 supported by the bearing 67 to move the pivot shaft 54 inward in the left-right direction. The front and rear pinion gears 55 of the pivot shaft 54 are respectively meshed with the rack gears 45, and can be rolled inward in the left-right direction. The front and rear pins 56 of the pivot shaft 54 are movable inward in the left-right direction along the elongated holes 48 of the front and rear support plates 46, respectively. Thus, when the operation portion 65 is pushed, the pivot shaft 54 moves inward in the left-right direction while being pivoted.

As the pivot shaft 54 moves in this manner, each of the front and rear pins 56 moves from the reference surface 75a to the inner inclined surface 75b in the accommodating recess 75. Each inner inclined surface 75b is inclined with respect to the reference surface 75a such that its inner side in the front-rear direction becomes closer to its inner side in the left-right direction. Thus, each of the front and rear shims 70 is pressed against the biasing force of the second spring 74 and moved outward in the front-rear direction. The moving direction of the shim 70 is a direction in which the shim 70 moves away from the pivot shaft 54 in the front-rear direction.

Then, as shown in FIG. 10, when the front and rear shims 70 are moved to the detaching position, the front and rear pins 56 are removed from the accommodating recess 75. Accordingly, the pivot shaft 54 and the support wall 21 (the box body 11) coupled together are decoupled from each other. That is, the lid 30 locked by the lock mechanism 60 is unlocked.

The pivot shaft 54 corresponding to the operation portion 65 that has not been pushed remains coupled to the support wall 21 (to the box body 11). This allows the lid 30 to pivot upward about the pivot shaft 54 corresponding to the operation portion 65 that has not been pushed. Thus, the lid 30 is pivoted upward about the pivot shaft 54 that remains coupled to the support wall 21. As the lid 30 pivots, the upper opening 14 opens. This allows an article outside the storage 20 to be stored in the storage 20 through the upper opening 14. This also allows an article stored in the storage 20 to be taken out of the storage 20 through the upper opening 14.

When the lid 30 is unlocked so that the operation portion 65 is no longer pushed, the first spring 68 corresponding to the operation portion 65 releases the biasing force stored in the first spring 68. The released biasing force moves the operation portion 65 outward in the left-right direction together with the pivot shaft 54 as shown in FIG. 9. Each of the front and rear pinion gears 55 of the pivot shaft 54 rolls outward in the left-right direction on the rack gear 45 meshed with the pinion gear 55. This prevents the pivot shaft 54 from moving in the left-right direction in a state of being inclined with respect to the front-rear direction. The pivot shaft 54 smoothly moves in the left-right direction while remaining in parallel to the first wall 18 of the support 13.

This movement causes the outer portion of the operation portion 65 in the left-right direction to protrude outward in the left-right direction from the entrance 62 of the operation base 61. The movement of the operation portion 65 and the pivoting of the pivot shaft 54 are stopped when the front and rear pins 56 come into contact with outer ends of the elongated holes 48 in the left-right direction, respectively.

Further, the biasing force stored in the second spring 74 is released on each of the front and rear support walls 21. The released biasing force causes each shim 70 to move inward in the front-rear direction as shown in FIG. 9. The movement of each shim 70 is restricted by each engagement portion 72 being locked to the peripheral portion of a corresponding engagement hole 24 in the shim accommodating portion 22.

When Two Operation Portion 65 are Simultaneously Pushed

The left and right operation portions 65 are independent of each other. Thus, when the two operation portions 65 are simultaneously pushed against the biasing force of the first spring 68, the same action as that in the section “When One Operation Portion 65 is Pushed” is performed on the two pivot shafts 54. When each of the two pivot shafts 54 is removed from a corresponding accommodating recess 75, the two pivot shafts 54 and the box body 11 coupled together are decoupled. This allows the lid 30 to be detached from the box body 11.

When the lid 30 is unlocked and is detached from the box body 11, the upper opening 14 opens. In the same manner as the section “When One Operation Portion 65 is Pushed,” this allows an article outside the storage 20 to be stored in the storage 20 through the upper opening 14. This also allows the article stored in the storage 20 to be taken out of the storage 20 through the upper opening 14.

In particular, when the upper opening 14 is opened by detaching the lid 30 from the box body 11, an article is readily taken in and out through the upper opening 14. When the lid 30 coupled to the box body 11 is pivoted to open the upper opening 14, the lid 30 is located at a position relatively close to the upper opening 14. Thus, the lid 30 may prevent an article from being taken in and out. This is because, when the lid 30 is detached, the lid 30 is not located at a position relatively close to the upper opening 14.

When the lid 30 is detached so that the two operation portions 65 are not pushed, the following effect is gained. As shown in FIG. 9, in the lid 30, each operation portion 65 is moved outward in the left-right direction together with the pivot shaft 54 by the biasing force of each of the left and right first springs 68. This causes the outer portion of the operation portion 65 in the left-right direction to protrude outward in the left-right direction from the entrance 62 of the operation base 61.

On the front and rear support walls 21, the shims 70 are moved inward in the front-rear direction by the biasing force of the second springs 74. The movement of each shim 70 is restricted by each engagement portion 72 being locked to the peripheral portion of a corresponding engagement hole 24 in the shim accommodating portion 22.

When Lid 30 is Attached to Box Body 11

The lid 30 can be attached to the box body 11 regardless of which one of the first surface 34 and the second surface 41 faces upward. When the lid 30 is attached to the box body 11, the lid 30 is pressed against the box body 11 from above. This causes the front and rear pins 56 of the left and right pivot shafts 54 to come into contact with the outer inclined surfaces 76 of the front and rear shims 70, respectively.

As shown in FIG. 5, the outer inclined surface 76 of each shim 70 is inclined such that its inner side in the front-rear direction becomes closer to its lower side. Thus, each shim 70 is pressed against the biasing force of the second spring 74 and moved outward in the front-rear direction. The moving direction of the shim 70 is a direction in which the shim 70 moves away from the pivot shaft 54 in the front-rear direction.

When the pin 56 of each pivot shaft 54 passes along the outer inclined surface 76 and descends to the central portion of the shim 70, the shim 70 biased by the second spring 74 moves inward in the front-rear direction. Thus, when the front and rear pins 56 of each pivot shaft 54 enter the accommodating recess 75 of the shim 70, the pivot shaft 54 is coupled to the box body 11. As a result, the console box 10 enters the same state as that in the section “When None of Operation Portions 65 is Pushed.”

Next, an operation obtained when the user uses the lid 30 as a chair will be described.

Referring to FIGS. 13 and 14, to use the lid 30 as a chair, the user first detaches the lid 30 from the box body 11 and then pivots each leg 81 from the fold position to the use position. Subsequently, the user disposes the lid 30 at a desired position outside or inside the vehicle such that the lid body 31 is supported from below by the legs 81. Afterwards, by sitting down on the first surface 34 of the lid body 31, the user can utilize the lid 30 as a chair. For example, the use of the lid 30 as a chair during camping, fishing, or the like is convenient in a case in which the number of chairs is insufficient, a case in which a chair cannot be prepared immediately, or the like.

In this case, the user can also use the lid 30 as a footrest by placing his foot on the first surface 34 of the lid body 31. Further, the user can use the lid 30 as a table by placing food or drink on the first surface 34 of the lid body 31. Furthermore, the user can use the lid 30 as a pillow by placing his head on the first surface 34 of the lid body 31 with each leg 81 pivoted from the use position to the fold position. After use, each leg 81 is moved to the fold position so that the lid 30 is attached to the box body 11.

In this manner, the legs 81 enable the user to use the lid 30 in a manner different from the opening and closing of the upper opening 14. Accordingly, the lid 30 includes the additional function portions (the legs 81 in the present embodiment) that enable the user to use the lid 30 in a manner different from the opening and closing of the upper opening 14.

### Advantages of First Embodiment

The first embodiment described above in detail has the following advantages.

(1-1) The console box 10 includes the box body 11 with the storage 20, which has the upper opening 14, and includes the lid 30, which is detachably coupled to the box body 11 and configured to open and close the upper opening 14. The lid 30 includes the additional function portion that enables the user to use the lid 30 in a manner different from the opening and closing of the upper opening 14.

This configuration adds the function corresponding to the needs to the lid 30 of the console box 10.

(1-2) The upper opening 14 is opened when the lid 30 is detached from the box body 11. The lid 30 includes the lid body 31 and the legs 81, which are disposed on one surface of the lid body 31 in the thickness direction. The additional function portion includes the legs 81. Each leg 81 is configured to be moved between the use position, at which the leg 81 is raised from the lid body 31, and the fold position, at which the leg 81 is folded.

In this configuration, the upper opening 14 of the storage 20 is opened and closed by, for example, pivoting the lid 30 that is coupled to the box body 11. Further, the upper opening 14 is opened when the lid 30 is detached from the box body 11.

When the upper opening 14 is opened, an article outside the storage 20 can be stored in the storage 20 through the upper opening 14. This also allows the article stored in the storage 20 to be taken out of the storage 20 through the upper opening 14.

In particular, when the upper opening 14 is opened by detaching the lid 30 from the box body 11, an article is readily taken in and out through the upper opening 14. When the lid 30 coupled to the box body 11 is pivoted to open the upper opening 14, the lid 30 is located at a position relatively close to the upper opening 14. Thus, the lid 30 may prevent an article from being taken in and out. This is because, when the lid 30 is detached from the box body 11, the lid 30 is not located at a position relatively close to the upper opening 14.

Further, when the upper opening 14 is closed by the lid 30 with an article stored in the storage 20, the lid 30 holds the article in the stored state. In this manner, the console box 10 provides a general function of storing an article in the storage 20.

When the lid 30 is decoupled from the box body 11 to detach the lid 30 from the box body 11, the lid 30 including the legs 81 can be carried to a place distant from the box body 11. In this case, the lid 30 can be used as a chair, a table, or the like by moving the leg 81 from the fold position to the use position.

(1-3) In the console box 10, the surface of the lid body 31 where the legs 81 are disposed has the storage recess 80, which stores the legs 81 when each leg 81 is moved to the fold position.

In this configuration, by storing each leg 81 in the storage recess 80, the leg 81 is prevented from becoming an obstacle when the lid 30 is detached from the box body 11 and then carried or when the lid 30 is attached to the box body 11.

(1-4) In the console box 10, the surface of the lid body 31 on the side opposite to the legs 81 is made of a material softer than that of the surface of the lid body 31 where the legs 81 are disposed.

This configuration enhances the seat comfort of the lid 30 when it is detached from the box body 11 and then used as a chair.

### Second Embodiment

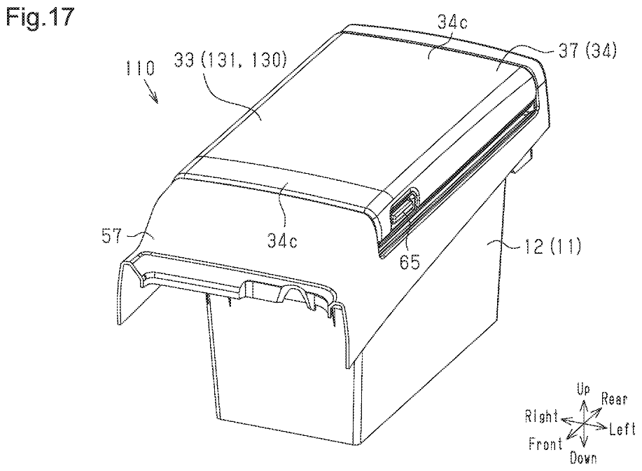

A console box 110 of the second embodiment will now be described with reference to FIGS. 17 to 26. The same components of the console box 110 as those of the console box 10 of the first embodiment are denoted by the same reference numerals. A lid 130, a lid body 131, a second halved body 139, and a second surface 141 of the console box 110, which will be described later, correspond to the lid 30, the lid body 31, the second halved body 39, and the second surface 41 of the first embodiment, respectively. Thus, in the description of the console box 110, the description overlapping with the description of the console box 10 of the first embodiment will be omitted.

Console Box 110

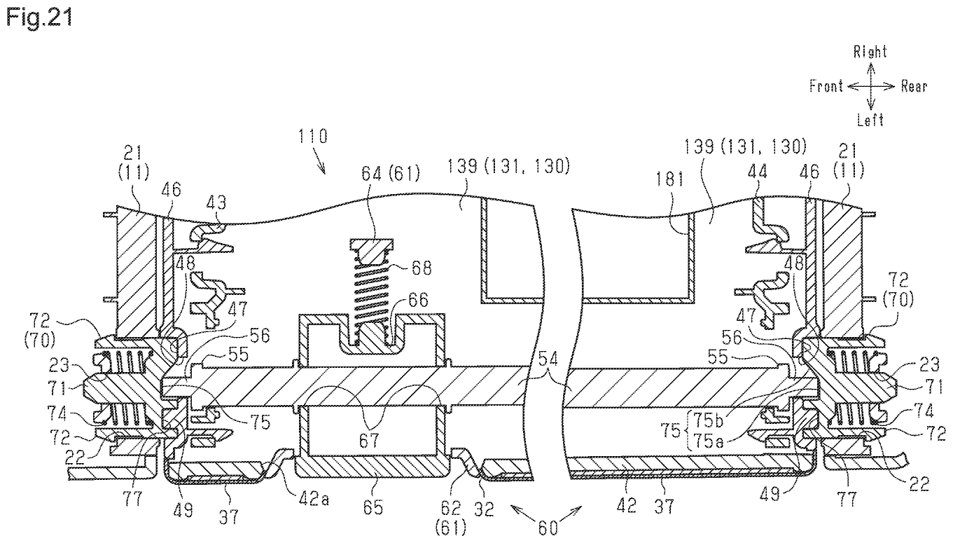

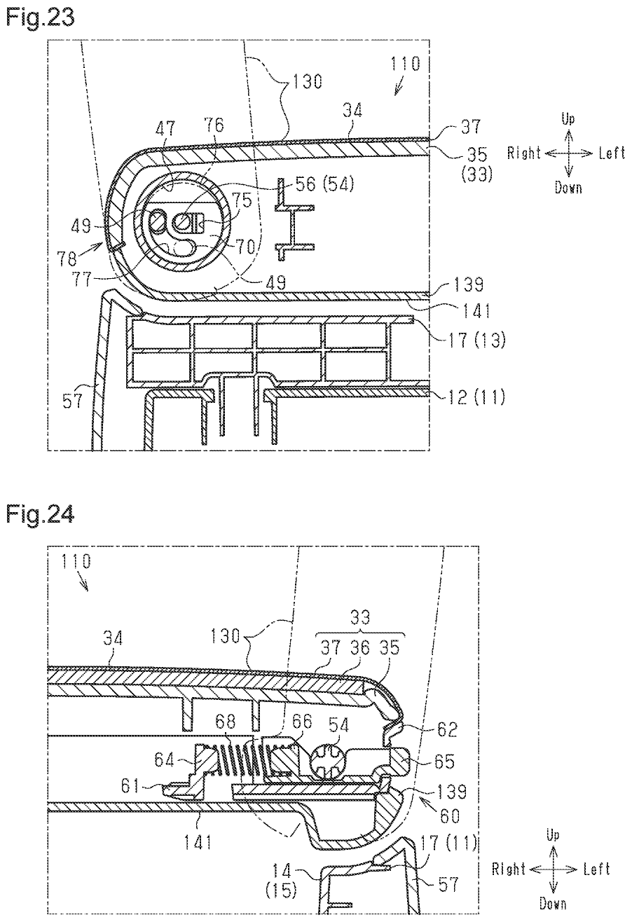

FIG. 17 shows the main section of the console box 110. In the same manner as the console box 10 of the first embodiment, the console box 110 is a part of the center console disposed between the driver's seat and the passenger seat in a passenger compartment. The console box 110 includes the box body 11, the lid 130, the housing 57, the first lock mechanism 60 (see FIG. 21), and the pivot range defining portion 78 (see FIG. 23).

Box Body 11

The box body 11 of the console box 110 has a configuration similar to that of the box body 11 (see FIGS. 2 to 5) of the console box 10 of the first embodiment. Thus, the box body 11 of the second embodiment will not be described in detail. In the second embodiment, the storage 20 in the first embodiment, that is, a storage including the space surrounded by the frame 17 and the internal space of the box portion 12 is referred to as a first storage 20. In the second embodiment, of the left-right direction and the front-rear direction of the box portion 12, the left-right direction, which is a direction having a smaller dimension, is defined as a width direction of the console box 110. That is, the width direction of the console box 110 coincides with a vehicle width direction (left-right direction).

Lid 130

As shown in FIG. 17, the lid 130 is detachably coupled to the box body 11. In a state in which the lid 130 is coupled to the box body 11, the lid 130 is pivotable between the closed position, at which the lid 130 closes the upper opening 14 as indicated by the solid line in FIG. 24, and the fully-open position, at which the lid 130 is raised to fully open the upper opening 14 as indicated by the long dashed double-short dashed line in FIG. 24. In other words, the lid 130 opens and closes the upper opening 14 by pivoting between the closed position and the fully-open position. Thus, the lid 130 with the upper opening 14 closed will hereinafter be described.

Basic Structure of Lid 130

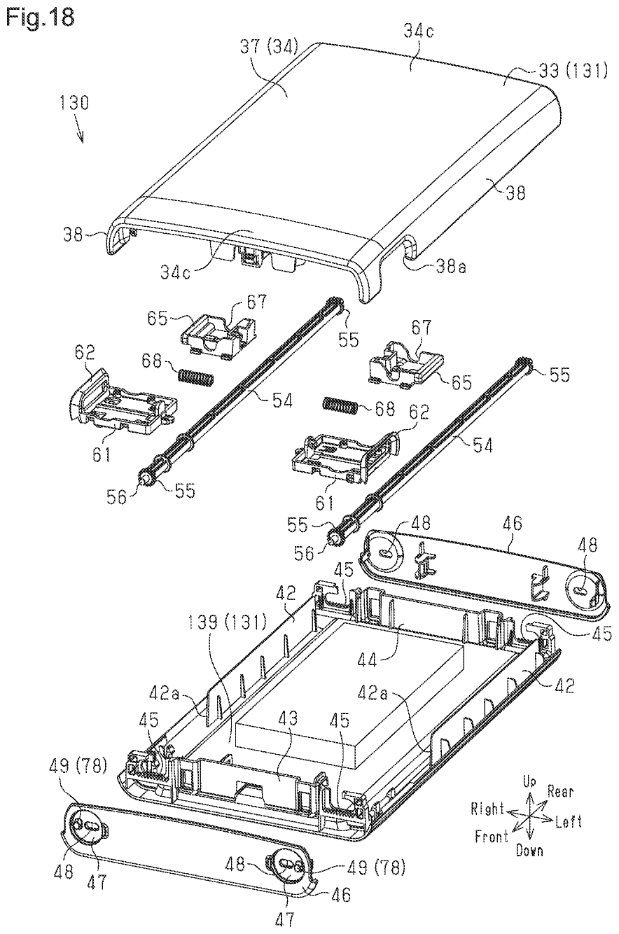

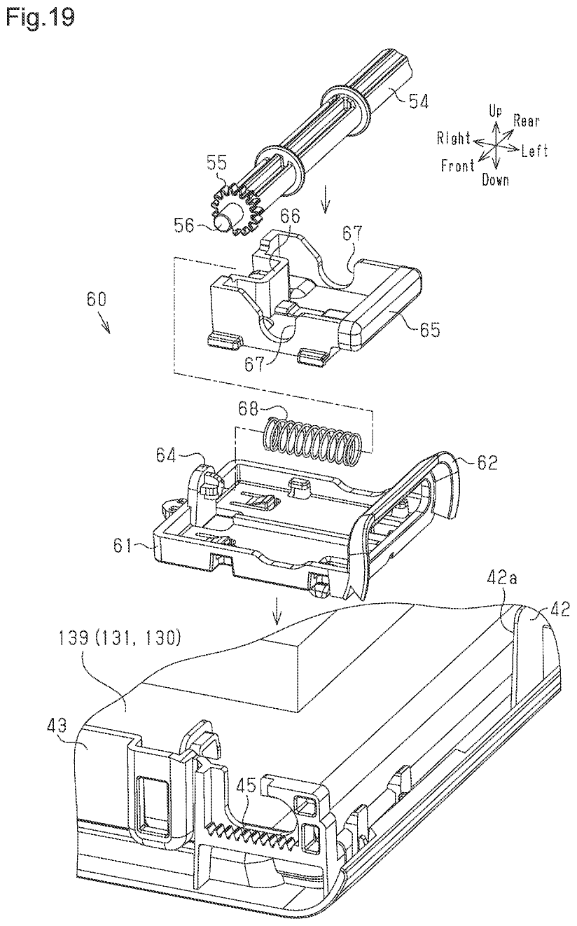

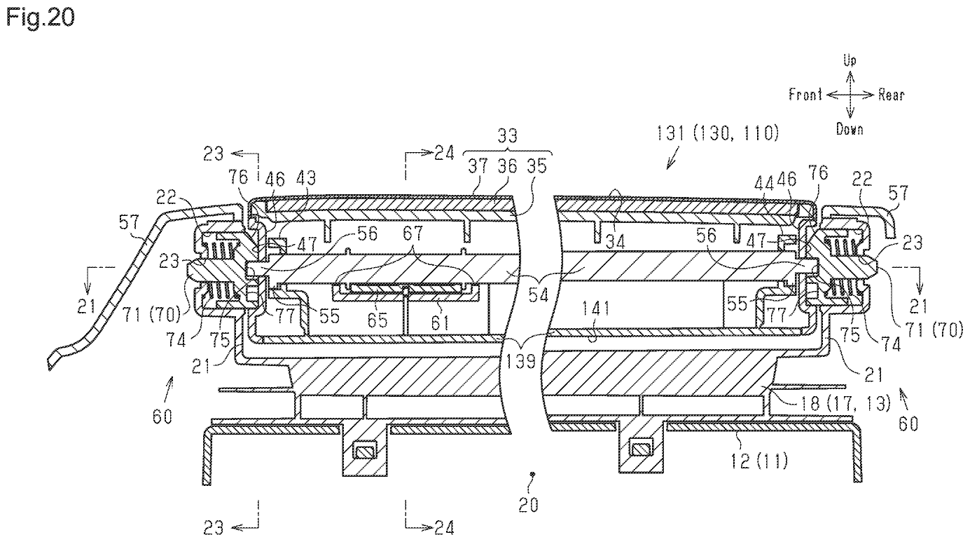

As shown in FIG. 18, the lid 130 includes the lid body 131, the two support plates 46, and the two pivot shafts 54. The lid body 131 is shaped and sized so as to close the upper opening 14 from above. The up-down direction of the lid body 131 is the thickness direction of the lid body 131. The lid body 131 includes the first halved body 33 located on one side in the thickness direction, and a second halved body 139 located on the other side of the lid body 131 and joined to the first halved body 33. FIG. 20 illustrates the lid 130 with the first halved body 33 located above the second halved body 139.

As shown in FIG. 20, the first halved body 33 includes the base 35, which is formed of a hard resin material, the cushion layer 36, which is laminated on the base 35 and formed of a foam, and the covering 37, which is laminated on the cushion layer 36. The portion of the covering 37 that is a surface of the lid 130 on one side in the thickness direction is the first surface 34 of the lid 130. That is, the first surface 34, which is one of the surfaces of the lid 130 in the thickness direction, is defined by the covering 37. At least a part of the first surface 34 of the lid 130 has an armrest surface. In the present embodiment, the entire first surface 34 is the armrest surface.

The entire second halved body 139 is formed of a hard resin material. The surface of the second halved body 139 on the opposite side (back side) to the first surface 34 in the thickness direction is the second surface 141 of the lid 130.

As shown in FIG. 18, the first halved body 33 includes the two side walls 38 in the left-right direction, and the front part of each side wall 38 has a corresponding notch 38a. Similarly, the second halved body 139 includes the two side walls 42 in the left-right direction, and the front part of each side wall 42 has a corresponding notch 42a. When the second halved body 139 is joined to the first halved body 33, the notches 38a, 42a form an operation hole 32 as shown in FIG. 21.

As shown in FIG. 18, the two support plates 46 are disposed on the opposite outer sides of the lid body 31 in the front-rear direction, respectively. The front support plate 46 is attached to the front wall 43 of the second halved body 139. The rear support plate 46 is attached to the rear wall 44 of the second halved body 139. The outer surface of each support plate 46 in the front-rear direction is a part of a side surface of the lid 130.

As shown in FIG. 20, the box body 11 and the lid 130 are shaped such that the lid 130 is detachable from and couplable to the box body 11 regardless of whether the first surface 34 or the second surface 141 of the lid 130 is oriented upward.

The two pivot shafts 54 function to pivotally couple the lid body 131 to the box body 11. As shown in FIG. 18, the pivot shafts 54 extend in the front-rear direction in parallel with each other on the opposite side portions of the lid body 131 in the left-right direction. The lid 130 is pivotable between the closed position and the fully-open position about one pivot shaft 54 selected from the two pivot shafts 54.

The pinion gears 55 are respectively disposed on the outer circumferences of the opposite ends of each pivot shaft 54 in the front-rear direction. The rack gears 45 are respectively disposed on the opposite side portions of each of the front wall 43 and the rear wall 44 of the second halved body 139 in the left-right direction. The pinion gear 55 at the front end of each pivot shaft 54 is meshed with the rack gear 45 of the front wall 43, and the pinion gear 55 at the rear end of each pivot shaft 54 is meshed with the rack gear 45 of the rear wall 44.

Each pivot shaft 54 includes a corresponding pin 56, which extends in the front-rear direction, on the outer side of the pinion gear 55 in the front-rear direction. The recesses 47 recessed inward in the front-rear direction are respectively disposed at the left and right side portions of each of the front and rear support plates 46. The bottom of each recess 47 has the elongated hole 48 that extends through the support plate 46 in the left-right direction. The pin 56 of each pivot shaft 54 is inserted through a corresponding elongated hole 48.

The lid 130 can pivot integrally with any one of the pivot shafts 54. The pinion gear 55 can roll on the rack gear 45. Each elongated hole 48 allows the pin 56 to move in the left-right direction, and defines the range of movement of the pin 56 in the left-right direction.

Housing 57

As shown in FIGS. 17 and 20, the housing 57 accommodates the box body 11 with the upper surface and the side surface of the lid 130 exposed. FIG. 17 shows only a part of the housing 57.

First Lock Mechanism 60

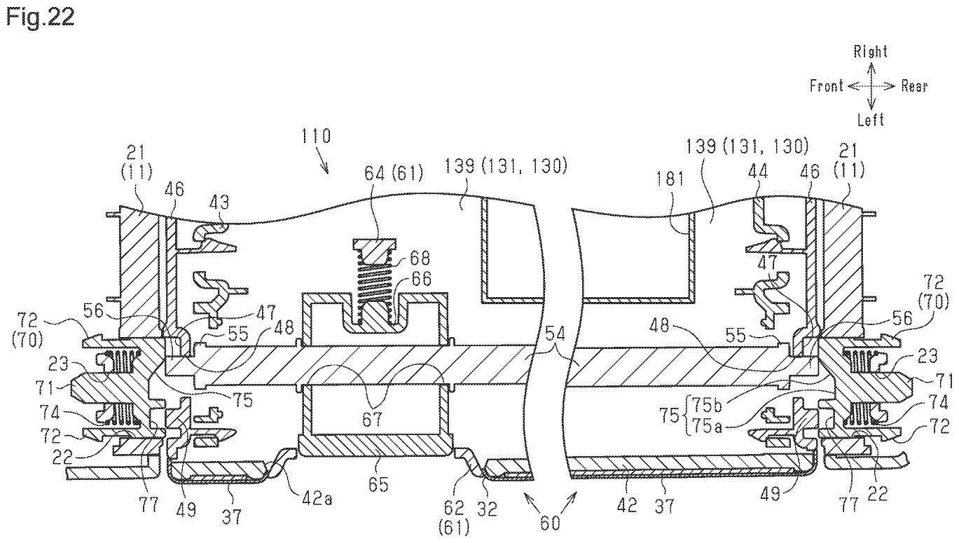

As shown in FIGS. 21 and 22, the first lock mechanism 60 functions to lock the lid 130 in a state in which the upper opening 14 is closed (i.e., lock the lid 130 at the closed position) and unlock the lid 130. The first lock mechanism 60 also functions to switch between the coupled state, in which each pivot shaft 54 is coupled to the box body 11, and the state in which they are decoupled.

As shown in FIG. 19, the first lock mechanism 60 has a configuration similar to that of the lock mechanism 60 (see FIG. 7) of the console box 10 in the first embodiment. Thus, the first lock mechanism 60 will not be described in detail.

Pivot Range Defining Portion 78

The pivot range defining portion 78 defines the pivot range of the lid 130 such that the lid 130 pivots between the closed position and the fully-open position, which have been described above. As shown in FIG. 23, the pivot range defining portion 78 of the console box 110 has a configuration similar to that of the pivot range defining portion 78 (see FIG. 11) of the console box 10 in the first embodiment. Thus, the pivot range defining portion 78 will not be described in detail.

Configuration of Lid 130 on Second Surface 141

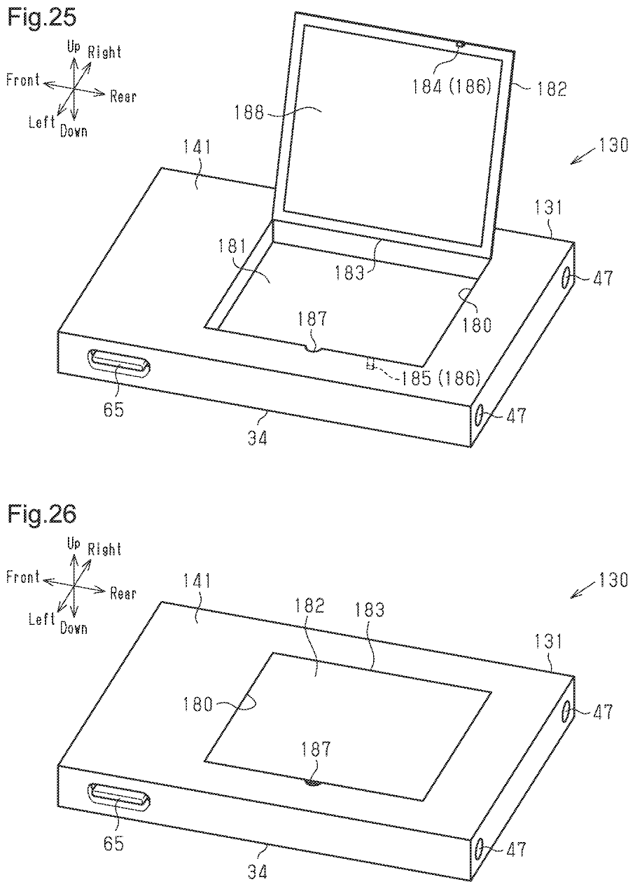

As shown in FIGS. 25 and 26, the second surface 141 of the lid 130, which is one surface of the lid 130 in the thickness direction, has a rectangular box-shaped second storage 181 and a rectangular lid member 182. The second storage 181 includes an opening 180 and a closed end. The lid member 182 is configured to open and close the opening 180. The lid member 182 is attached to the lid body 131 by a hinge 183 on the right side of the opening 180. The lid member 182 is configured to pivot about the hinge 183 between a first position (the position illustrated in FIG. 26) at which the opening 180 is closed and a second position (a position illustrated in FIG. 25) at which the opening 180 is opened.

An engagement tab 184 is disposed at an end of the lid member 182 on a side opposite to the hinge 183. The left surface of the second storage 181 in the lid body 131 has an engagement recess 185 that engages with the engagement tab 184 to lock the lid member 182 at the first position when the lid member 182 is pivoted to the first position. In the present embodiment, the engagement tab 184 and the engagement recess 185 are included in a second lock mechanism 186 that locks the lid member 182 at the first position, at which the opening 180 is closed. That is, the lid 130 includes the second lock mechanism 186.

The central portion of the opening 180 in the second surface 141 on the left side in the front-rear direction has a semicircular finger hooking recess 187 used to hook a finger on the lid member 182 when the lid member 182 at the first position is pivoted to the second position. The back surface (inner surface) of the lid member 182 has a rectangular mirror 188.

The lid member 182 locked at the first position by the second lock mechanism 186 is unlocked when a force greater than or equal to a predetermined magnitude is applied to the second position by hooking a finger. That is, when the finger is hooked so that the lid member 182 locked at the first position receives a force of the predetermined magnitude or more that acts toward the second position, the engagement tab 184 is elastically deformed so that the engagement tab 184 is disengaged from the engagement recess 185.

Next, the operation of the console box 110 will be described. As described above, the same components of the console box 110 as those of the console box 10 of the first embodiment are denoted by the same reference numerals. The lid 130, the lid body 131, the second halved body 139, and the second surface 141 correspond to the lid 30, the lid body 31, the second halved body 39, and the second surface 41 of the first embodiment, respectively. Thus, the description of the operation overlapping with that of the console box 10 of the first embodiment will be omitted.

When None of Operation Portions 65 is Pushed

The operation gained when none of the operation portions 65 is pushed is the same as operation described in the section “When None of Operation Portions 65 is Pushed” in the first embodiment. Thus, in the second embodiment, the detailed description is omitted.

When One Operation Portion 65 is Pushed

The operation gained when one of the operation portions 65 is pushed is the same as operation described in the section “When One Operation Portion 65 is Pushed” in the first embodiment. Thus, in the second embodiment, the detailed description is omitted.

When Two Operation Portions 65 are Simultaneously Pushed

The operation gained when the two operation portions 65 are simultaneously pushed is the same as operation described in the section “When Two Operation Portions 65 are Simultaneously Pushed” in the first embodiment. Thus, in the second embodiment, the detailed description is omitted.

When Lid 130 is Attached to Box Body 11

The operation gained when the lid 130 is attached to the box body 11 is the same as the operation described in the section “When Lid 30 is Attached to Box Body 11” of the first embodiment. Thus, in the second embodiment, the detailed description is omitted.

Next, the operation obtained when the user uses the lid 130 as a small item container will be described.

Referring to FIGS. 25 and 26, when the user uses the lid 130 as a small item container, the user first pivots the lid member 182 from the first position to the second position to expose the opening 180 of the second storage 181. Subsequently, the user puts a small item to be stored into the second storage 181 through the opening 180. Thereafter, the user pivots the lid member 182 from the second position to the first position to close the opening 180 of the second storage 181. This causes the lid member 182 to be locked by the second lock mechanism 186.

When the lid 130 attached to the box body 11 is used as a small item container, the user attaches the lid 130 to the box body 11 with the second surface 141 facing upward. When there is no need to put a small item in and out of the second storage 181 of the lid 130 for a relatively long time, the user may attach the lid 130 to the box body 11 with the first surface 34 facing upward. When the user uses the lid 130 detached from the box body 11 as a small item container, the lid 130 functions as a portable small item container.

When the small item stored in the second storage 181 is a cosmetic tool, the lid 130 functions as a portable cosmetic pouch. In this case, when the user pivots the lid member 182 from the first position to the second position to expose the opening 180 of the second storage 181, the mirror 188 on the back surface of the lid member 182 appears. Thus, the mirror 188 can be immediately used only by opening the lid member 182 (pivoting to the second position), which is convenient for makeup or touch-up.

In this manner, the second storage 181 enables the user to use the lid 130 in a manner different from the opening and closing of the upper opening 14. Accordingly, the lid 130 includes the additional function portion (the second storage 181 in the present embodiment) that enables the user to use the lid 130 in a manner different from the opening and closing of the upper opening 14.

### Advantages of Second Embodiment

The second embodiment described above in detail has the following advantages.

(2-1) The console box 110 includes the box body 11 with the storage 20 (first storage 20), which has the upper opening 14, and the lid 130 detachably coupled to the box body 11 and configured to open and close the upper opening 14. The lid 130 includes the additional function portion that enables the user to use the lid 130 in a manner different from the opening and closing of the upper opening 14.

This configuration adds the function corresponding to the needs to the lid 130 of the console box 110.

(2-2) The lid 130 includes the first lock mechanism 60, which is configured to lock the upper opening 14 in the closed state, and the operation portion 65, which is configured to unlock, when operated, the lid 130 locked by the first lock mechanism 60. The second surface 141 of the lid 130 has the second storage 181 with the opening 180, and has the lid member 182, which is configured to open and close the opening 180. The additional function portion includes the second storage 181.

In this configuration, the upper opening 14 of the first storage 20 is opened and closed by pivoting the lid 130 that is coupled to the box body 11. Further, the upper opening 14 is opened when the lid 130 is detached from the box body 11.

When the upper opening 14 is opened, an article outside the first storage 20 can be stored in the first storage 20 through the upper opening 14. This also allows the article stored in the first storage 20 to be taken out of the first storage 20 through the upper opening 14.

In particular, when the upper opening 14 is opened by detaching the lid 130 from the box body 11, an article is readily taken in and out through the upper opening 14. When the lid 130 coupled to the box body 11 is pivoted to open the upper opening 14, the lid 130 is located at a position relatively close to the upper opening 14. Thus, the lid 130 may prevent an article from being taken in and out. This is because, when the lid 130 is detached from the box body 11, the lid 130 is not located at a position relatively close to the upper opening 14.

Further, when the upper opening 14 is closed by the lid 130 with an article stored in the first storage 20, the lid 130 holds the article in the stored state. In this manner, the console box 110 provides a general function of storing an article in the first storage 20.

The second surface 141 of the lid 130, which is one surface of the lid 130 in the thickness direction, has the second storage 181. Thus, an article can be stored in the second storage 181 as well as the first storage 20.

When the lid 130 locked by the first lock mechanism 60 is unlocked by operating the operation portion 65 to detach the lid 130 from the box body 11, the lid 130 including the second storage 181 can be carried to a place distant from the box body 11. This allows the lid 130 to be used as a portable case.

(2-3) In the console box 110, the lid 130 includes the second lock mechanism 186, which locks the lid member 182 in a state in which the opening 180 is closed.

In this configuration, the lid member 182 is locked in a state in which the opening 180 of the second storage 181 is closed by the second lock mechanism 186. This prevents the lid member 182 from being opened unintentionally.

(2-4) In the console box 110, the lid 130 includes the lid body 131, the two pivot shafts 54, which extends in the direction orthogonal to the width direction on the opposite sides of the lid body 131 in the width direction and is configured to couple the lid body 131 to the box body 11, and the two operation portions 65, which are disposed in correspondence with the two pivot shafts 54 as members of the first lock mechanism 60 and configured to decouple the pivot shafts 54 from the box body 11 when operated. The two operation portions 65 are independent from each other. When one of the two operation portions 65 is operated, the lid 130 is configured to pivot about the pivot shaft 54 corresponding to the other one of the two operation portions 65 that is not operated and is coupled to the box body 11.

This configuration allows the lid 130 to be opened from one side in the width direction by operating one of the two operation portions 65, and allows the lid 130 to be opened from the other side in the width direction by operating the other one of the two operation portions 65. That is, the lid 130 can be opened from either side in the width direction. This enhances the ease of use when opening and closing the lid 130.

(2-5) In the console box 110, the first surface 34, which is one surface of the lid 130, is defined by the covering 37.

In this configuration, the covering 37 enhances the appearance of the lid 130.

(2-6) In the console box 110, the back surface of lid member 182 has the mirror 188.

In this configuration, since the mirror 188 is provided on the back surface of the lid member 182, when a cosmetic tool is stored as a small item in the second storage 181 of the lid 130, the user can immediately use the mirror 188 for makeup or touch-up with the cosmetic tool.

### Third Embodiment

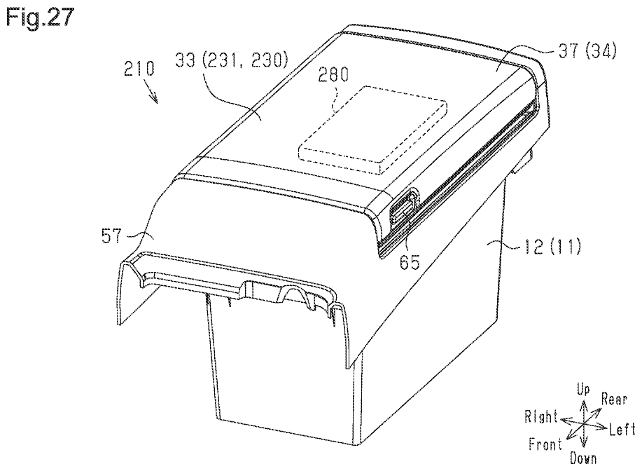

A console box 210 of the third embodiment will now be described with reference to FIGS. 27 to 37. The same components of the console box 210 as those of the console box 10 of the first embodiment are denoted by the same reference numerals. A lid 230, a lid body 231, a second halved body 239, and a second surface 241 of the console box 210, which will be described later, correspond to the lid 30, the lid body 31, the second halved body 39, and the second surface 41 of the first embodiment, respectively. Thus, in the description of the console box 210, the description overlapping with the description of the console box 10 of the first embodiment will be omitted.

Console Box 210

FIG. 27 shows the main section of the console box 210. In the same manner as the console box 10 of the first embodiment, the console box 210 is a part of the center console disposed between the driver's seat and the passenger seat in a passenger compartment.

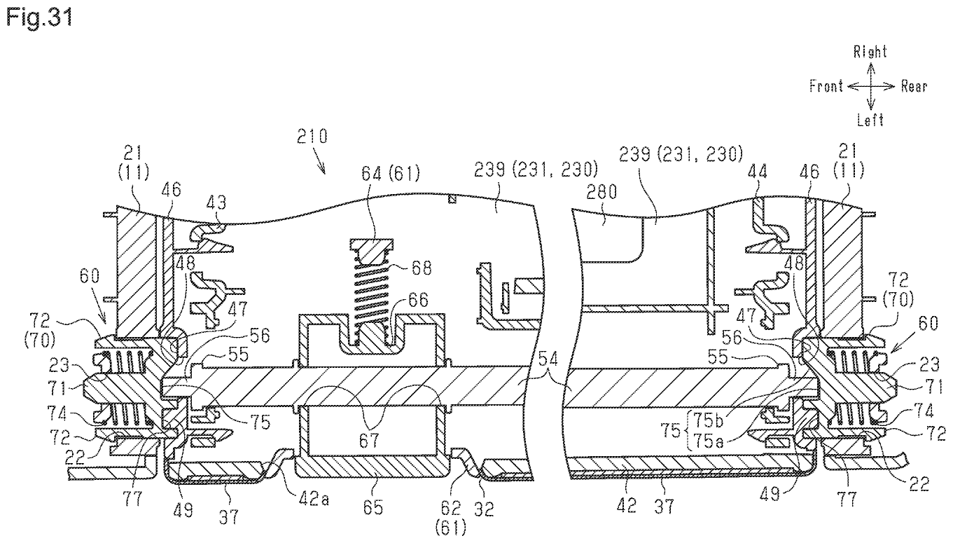

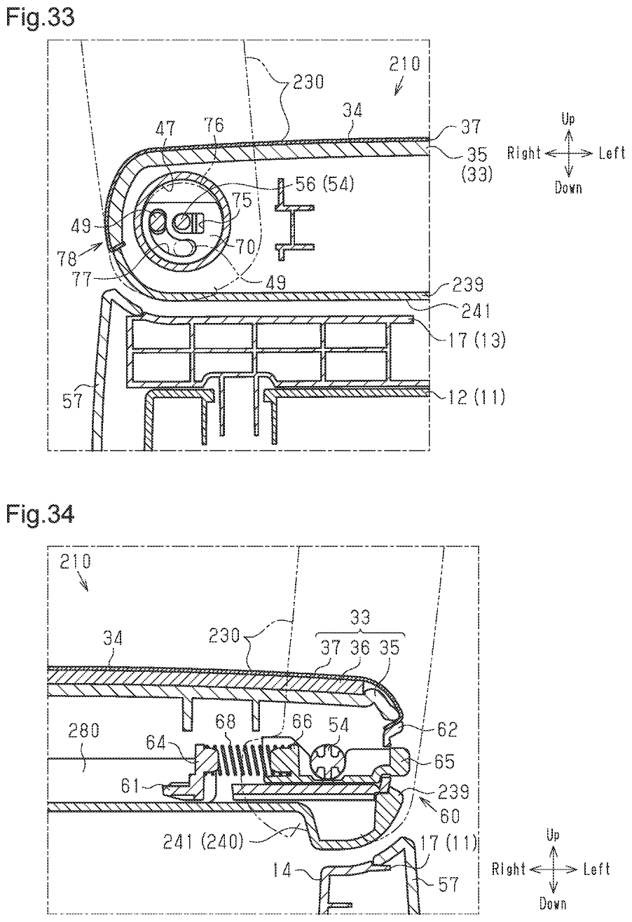

The console box 210 includes the box body 11, the lid 230, the housing 57, the lock mechanism 60 (see FIG. 31), and the pivot range defining portion 78 (see FIG. 33).

Box Body 11

The box body 11 of the console box 210 has a configuration similar to that of the box body 11 (see FIGS. 2 to 5) of the console box 10 of the first embodiment. Thus, the box body 11 will not be described in detail.

Lid 230

The lid 230 is detachably coupled to the box body 11. In a state in which the lid 230 is coupled to the box body 11, the lid 230 is pivotable between the closed position, at which the lid 230 closes the upper opening 14 as indicated by the solid line in FIG. 34, and the fully-open position, at which the lid 230 is raised to fully open the upper opening 14 as indicated by the long dashed double-short dashed line in FIG. 34. In other words, the lid 230 opens and closes the upper opening 14 by pivoting between the closed position and the fully-open position. Thus, the lid 230 with the upper opening 14 closed will hereinafter be described.

Basic Structure of Lid 230

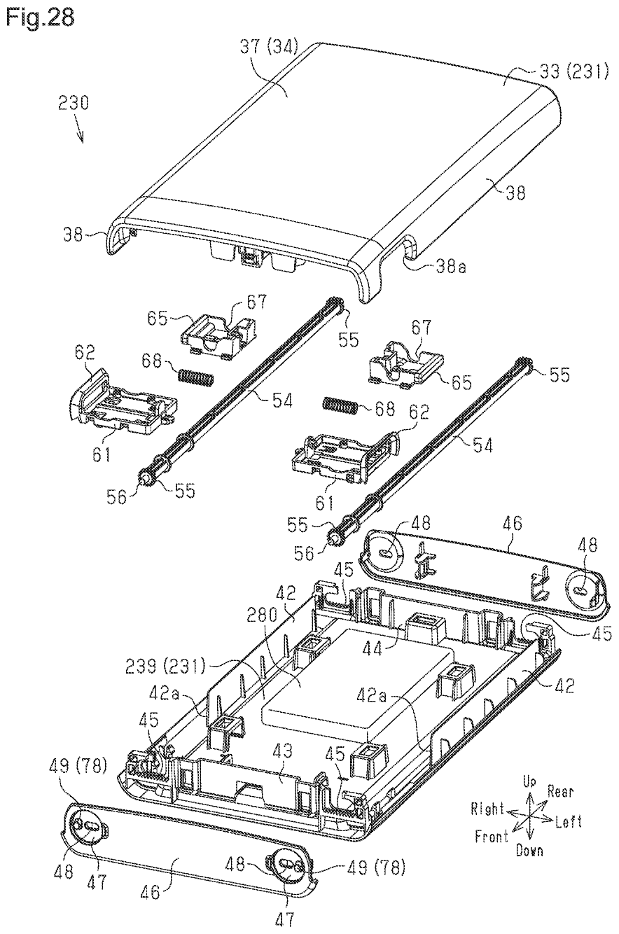

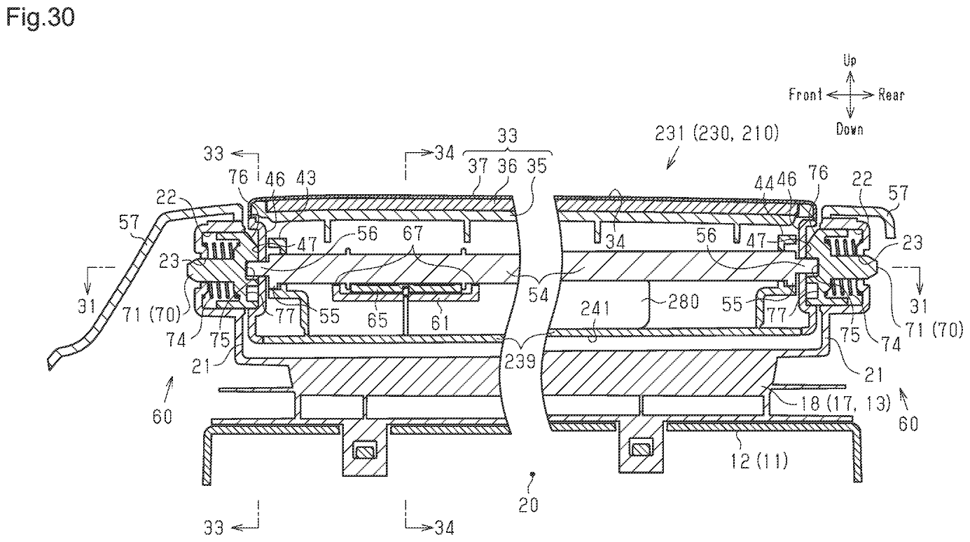

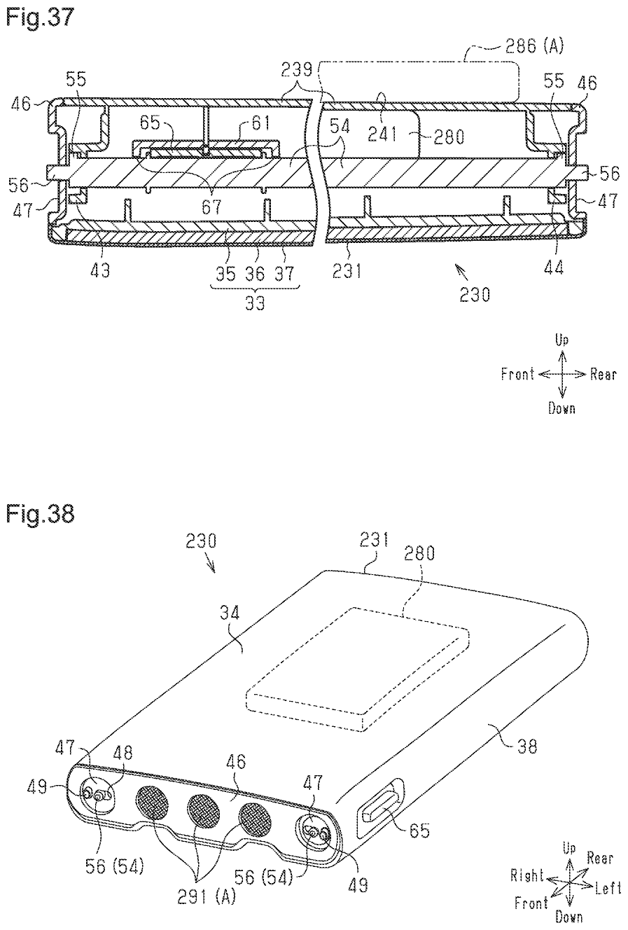

As shown in FIG. 28, the lid 230 includes the lid body 231, the two support plates 46, and the two pivot shafts 54. The lid body 231 is shaped and sized so as to close the upper opening 14 from above. The up-down direction of the lid body 231 is the thickness direction of the lid body 231. The lid body 231 includes the first halved body 33 located on one side in the thickness direction and a second halved body 239 located on the other side and joined to the first halved body 33. FIG. 30 illustrates the lid 230 with the first halved body 33 located above the second halved body 239. FIG. 37 illustrates the lid 230 with the second halved body 239 located above the first halved body 33.

As shown in FIG. 30, the first halved body 33 includes the base 35, which is formed of a hard resin material, the cushion layer 36, which is laminated on the base 35 and formed of a foam, and the covering 37, which is laminated on the cushion layer 36. The portion of the covering 37 that is a surface of the lid 230 on one side in the thickness direction is the first surface 34 of the lid 230. At least a part of the first surface 34 has an armrest surface. In the present embodiment, the entire first surface 34 is the armrest surface.

The entire second halved body 239 is formed of a hard resin material. The second halved body 239 has a recess 240 that opens outward in the thickness direction (see FIG. 34). The surface of the second halved body 239 on the opposite side (back side) to the first surface 34 in the thickness direction is the second surface 241 of the lid 230. A portion of the second surface 241 inside the recess 240 is used as a tray surface.

As shown in FIG. 28, the first halved body 33 includes the two side walls 38 in the left-right direction, and the front part of each side wall 38 has a corresponding notch 38a. Similarly, the second halved body 239 includes the two side walls 42 in the left-right direction, and the front part of each side wall 42 has a corresponding notch 42a. When the second halved body 239 is joined to the first halved body 33, the notches 38a, 42a form the operation hole 32 (see FIG. 31.)

As shown in FIG. 28, the two support plates 46 are disposed on the opposite outer sides of the lid body 231 in the front-rear direction, respectively. The front support plate 46 is attached to the front wall 43 of the second halved body 239. The rear support plate 46 is attached to the rear wall 44 of the second halved body 239.

As shown in FIG. 30, the box body 11 and the lid 230 are shaped such that the lid 230 is detachable from and couplable to the box body 11 regardless of whether the first surface 34 or the second surface 241 of the lid 230 is oriented upward.

The two pivot shafts 54 function to pivotally couple the lid body 231 to the box body 11. As shown in FIG. 28, the pivot shafts 54 extend in the front-rear direction in parallel with each other on the opposite side portions of the lid body 231 in the left-right direction.

The lid 230 is pivotable between the closed position and the fully-open position about one pivot shaft 54 selected from the two pivot shafts 54.

The pinion gears 55 are respectively disposed on the outer circumferences of the opposite ends of each pivot shaft 54 in the front-rear direction. Further, the rack gears 45 are respectively disposed on the opposite side portions of each of the front wall 43 and the rear wall 44 of the second halved body 239 in the left-right direction. The pinion gear 55 at the front end of each pivot shaft 54 is meshed with the rack gear 45 of the front wall 43, and the pinion gear 55 at the rear end of each pivot shaft 54 is meshed with the rack gear 45 of the rear wall 44.

Each pivot shaft 54 includes a corresponding pin 56, which extends in the front-rear direction, on the outer side of the pinion gear 55 in the front-rear direction. The recesses 47 recessed inward in the front-rear direction are respectively disposed at the left and right side portions of each of the front and rear support plates 46. The bottom of each recess 47 has the elongated hole 48 that extends through the support plate 46 in the left-right direction. The pin 56 of each pivot shaft 54 is inserted through a corresponding elongated hole 48.

The lid 230 can pivot integrally with any one of the pivot shafts 54. The pinion gear 55 can roll on the rack gear 45. Each elongated hole 48 allows the pin 56 to move in the left-right direction, and defines the range of movement of the pin 56 in the left-right direction.

Housing 57

As shown in FIGS. 27 and 30, the housing 57 accommodates the box body 11 with the upper surface and the side surface of the lid 230 exposed. FIG. 27 shows only a part of the housing 57.

Lock Mechanism 60

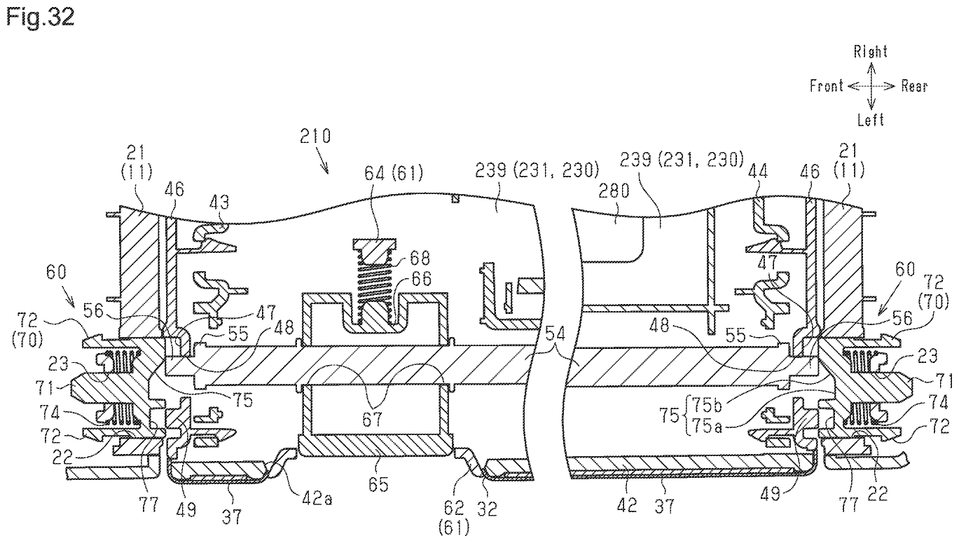

As shown in FIGS. 31 and 32, the lock mechanism 60 functions to lock the lid 230 in a state in which the upper opening 14 is closed (i.e., lock the lid 230 at the closed position) and unlock the lid 230. The lock mechanism 60 also functions to switch between the coupled state, in which each pivot shaft 54 is coupled to the box body 11, and the state in which they are decoupled.

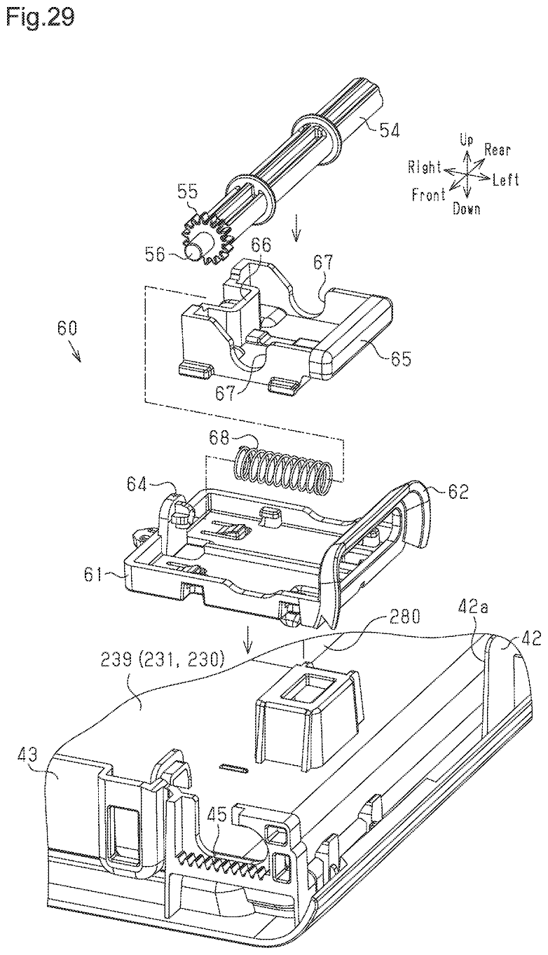

As shown in FIG. 29, the lock mechanism 60 of the console box 210 has a configuration similar to that of the lock mechanism 60 (see FIG. 7) of the console box 10 in the first embodiment. Thus, the lock mechanism 60 will not be described in detail.

Pivot Range Defining Portion 78

The pivot range defining portion 78 defines the pivot range of the lid 230 such that the lid 230 pivots between the closed position and the fully-open position, which have been described above. As shown in FIG. 33, the pivot range defining portion 78 of the console box 210 has a configuration similar to that of the pivot range defining portion 78 (see FIG. 11) of the console box 10 in the first embodiment. Thus, the pivot range defining portion 78 will not be described in detail.

Battery 280

Further, as shown in FIGS. 27, 28, and the like, a battery 280 is accommodated in the lid body 231. The battery 280 is a part of a power supply system that supplies power to an electronic device A, and is fixed to the lid body 231 using a method (e.g., screw fastening). As shown in FIGS. 36 and 37, in the third embodiment, the electronic device A is a mobile terminal 286, which is a portable communication device (e.g., a smartphone, a mobile phone, or a wearable device). A smartphone is a portable telephone terminal having many functions in addition to a call function as a mobile phone. A smartphone has, for example, an imaging function provided by a camera, a web information display function like a personal computer (hereinafter simply referred to as PC), and the like. A wearable device is worn on a living body (e.g., a human body), and is typically a wearable terminal (e.g., a smart watch or smart glasses).

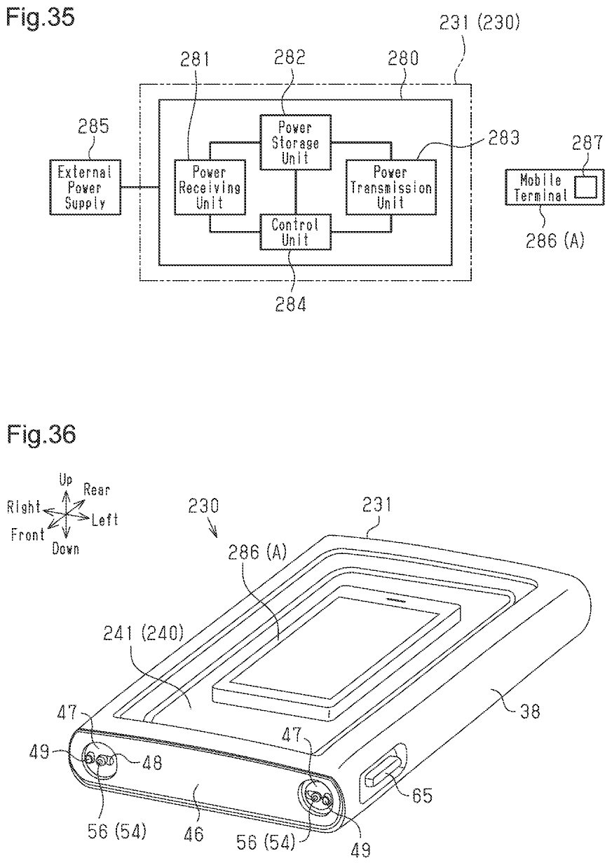

Although not illustrated, the mobile terminal 286 includes a CPU, a memory, a display, an input device, a communication device, and the like. As shown in FIG. 35, a power storage unit 287 including a rechargeable battery is incorporated in the mobile terminal 286. The mobile terminal 286 is configured to provide its function using the power storage unit 287 as a power source. The power supplied from the battery 280 to the mobile terminal 286 is stored in the power storage unit 287.

The battery 280 includes a power receiving unit 281 (power receiving circuit), a power storage unit 282, a power transmission unit 283 (power transmission circuit), and a control unit 284. The power receiving unit 281 is connected to an external power supply 285 via a connector, a cable, or the like, and receives the power supplied from the external power supply 285. In the third embodiment, a vehicle on-board battery is used as the external power supply 285. The external power supply 285 and the electronic device A are included in the power supply system together with the battery 280.

The power storage unit 282 is a rechargeable battery that can be repeatedly charged and discharged, such as a nickel-metal hydride battery or a lithium-ion rechargeable battery. The power transmission unit 283 transmits (supplies) some of the power stored in the power storage unit 282 to the mobile terminal 286. The control unit 284 includes, for example, a hardware processor such as a CPU configured to execute a program (software). That is, the control unit 284 may be circuitry including: 1) one or more processors that operate according to a computer program (software); 2) one or more dedicated hardware circuits such as application specific integrated circuits (ASICs) that execute at least part of various processes; or 3) a combination thereof. The processor includes a CPU and a memory such as a RAM and a ROM. The memory stores program codes or commands configured to cause the CPU to execute processes. The memory, or a computer-readable medium, includes any type of media that are accessible by general-purpose computers and dedicated computers. The control unit 284 controls the transmission (supply) of power from the power transmission unit 283 to the mobile terminal 286. Based on the charging state of the power storage unit 282, the control unit 284 controls the storage of power received through the power receiving unit 281 in the power storage unit 282.

Power is supplied from the power transmission unit 283 of the battery 280 to the mobile terminal 286 using a non-contact (wireless) power transmission method, in which power can be transmitted without using a metal contact, a connector, or the like. This method is also called contactless power supply, contactless power transmission, or the like. In the present embodiment, non-contact power transmission with an electromagnetic induction method is employed among non-radiation methods that can be used in a relatively close region. The power transmission unit 283 (power transmission circuit) of the battery 280 includes, as a primary coil, a power transmitting coil that generates a magnetic field (magnetic flux) when current is supplied to the power transmission unit 283. The power transmitting coil is disposed in the lid body 231 at a position relatively close to the second surface 241 of the lid body 231.

The mobile terminal 286 includes a power receiving coil as a secondary coil. When the mobile terminal 286 is placed on second surface 241 to move the power receiving coil toward the power transmitting coil, the two coils are electromagnetically coupled to each other to convert the magnetic field into power. The converted power is stored in the power storage unit 287 of the mobile terminal 286.

Instead of the electromagnetic induction method, a magnetic field resonance method, an electric field coupling method, a radio wave field coupling method, a radio wave receiving method, or the like may be used as a non-contact power transmission method.

Next, the operation of the console box 210 will be described. As described above, the same components of the console box 210 as those of the console box 10 of the first embodiment are denoted by the same reference numerals. The lid 230, the lid body 231, the second halved body 239, and the second surface 241 correspond to the lid 30, the lid body 31, the second halved body 39, and the second surface 41 of the first embodiment, respectively. Thus, the description of the operation overlapping with that of the console box 10 of the first embodiment will be omitted.

When None of Operation Portions 65 is Pushed

The operation gained when none of the operation portions 65 is pushed is the same as operation described in the section “When None of Operation Portions 65 is Pushed” in the first embodiment. Thus, in the third embodiment, the detailed description is omitted.

Additionally, in the third embodiment, although not shown, if the lid 230 locked at the closed position with the second surface 241 facing upward, the second surface 241 can function as a tray surface on which an article is placed. In other words, the lid 230 may function as a tray.

When One Operation Portion 65 is Pushed

The operation gained when one of the operation portions 65 is pushed is the same as operation described in the section “When One Operation Portion 65 is Pushed” in the first embodiment. Thus, in the third embodiment, the detailed description is omitted.

When Two Operation Portion 65 are Simultaneously Pushed

The operation gained when the two operation portions 65 are simultaneously pushed is the same as operation described in the section “When Two Operation Portion 65 are Simultaneously Pushed” in the first embodiment. Thus, in the third embodiment, the detailed description is omitted.

When Lid 230 is Attached to Box Body 11

The operation gained when the lid 230 is attached to the box body 11 is the same as the operation described in the section “When Lid 30 is Attached to Box Body 11” of the first embodiment. Thus, in the third embodiment, the detailed description is omitted.

Supply of Power to Mobile Terminal 286

As shown in FIG. 35, in the battery 280 accommodated in the lid body 231, the power supplied from the external power supply 285 to the power receiving unit 281 is stored in the power storage unit 282 by the control unit 284 controlling the power receiving unit 281. When the mobile terminal 286 is electrically connected to the battery 280, the power stored in power storage unit 282 is transmitted to the mobile terminal 286 by the control unit 284 controlling the power transmission unit 283.

In the third embodiment, the power stored in the power storage unit 282 is transmitted to the mobile terminal 286 through contactless power supply. Thus, when the mobile terminal 286 of a type that allows for contactless power supply is placed on the second surface 241 as shown in FIG. 36 to move the power receiving coil toward the power transmitting coil, the mobile terminal 286 is electrically connected to the battery 280. Thus, the two coils are electromagnetically coupled to each other to convert the magnetic field into power. The converted power is stored in the power storage unit 287 of the mobile terminal 286.

When the amount of power remaining in the power storage unit 282 (the remaining battery level) decreases as power is supplied to the mobile terminal 286, the power receiving unit 281 is controlled by the control unit 284 so that the power supplied from the external power supply 285 to the power receiving unit 281 is stored in the power storage unit 282.

Further, when the lid 230 is detached from the box body 11, the lid 230 accommodating the battery 280 can be carried to a place distant from the box body 11. In this case, the battery 280 can function as a mobile battery that supplies power to the power storage unit 287 of the mobile terminal 286, while being a part of the lid 230.

In this manner, the battery 280 enables the user to use the lid 230 in a manner different from the opening and closing of the upper opening 14. Accordingly, the lid 230 includes the additional function portion (the battery 280 in the present embodiment) that enables the user to use the lid 230 in a manner different from the opening and closing of the upper opening 14.

### Advantages of Third Embodiment

The third embodiment described above in detail has the following advantages.

(3-1) As shown in FIGS. 33 and 34, the lid 230, which is configured to open and close the upper opening 14 of the storage 20, is detachably connected to the box body 11.

The upper opening 14 is opened and closed by pivoting the lid 230 coupled to the box body 11 about one pivot shaft 54. The upper opening 14 is opened by detaching the lid 230 from the box body 11.

When the upper opening 14 is opened, an article outside the storage 20 can be stored in the storage 20 through the upper opening 14. Further, the article stored in the storage 20 can be taken out of the storage 20 through the upper opening 14.

Further, when the upper opening 14 is closed with an article stored in the storage 20, the lid 230 holds the article in the stored state.

In this manner, the console box 210 provides a general function of storing an article in the storage 20.

In particular, when the upper opening 14 is opened by detaching the lid 230 from the box body 11, an article is readily taken in and out through the upper opening 14.

(3-2) The console box 210 includes the box body 11 with the storage 20, which has the upper opening 14, and the lid 230, which is detachably coupled to the box body 11 and configured to open and close the upper opening 14. The lid 230 includes the additional function portion that enables the user to use the lid 230 in a manner different from the opening and closing of the upper opening 14.

This configuration adds the function corresponding to the needs to the lid 230 of the console box 210.

(3-3) In the third embodiment, as shown in FIG. 28, the battery 280 is accommodated in the lid body 231. The additional function portion includes the battery 280. Thus, as shown in FIG. 35, the power supplied from the external power supply 285 can be stored in the power storage unit 282. When the mobile terminal 286 is electrically connected to the battery 280, the power stored in the power storage unit 282 can be transmitted from the power transmission unit 283 to the mobile terminal 286 and stored in the power storage unit 287.

When the remaining battery level of the power storage unit 282 decreases as power is supplied to the mobile terminal 286, the remaining battery level can be increased by storing the power supplied from the external power supply 285 in the power storage unit 282.

As shown in FIGS. 36 and 37, the lid body 231 can be carried to a place distant from the box body 11 together with the battery 280 by detaching the lid 230 from the box body 11. The lid 230 can function as a mobile battery. The user can charge the mobile terminal 286 using the lid 230 (battery 280) at a place distant from the box body 11 and even outside the vehicle.

(3-4) In the third embodiment, as shown in FIG. 35, the power transmission unit 283 of the battery 280 can supply the power stored in the power storage unit 282 to the mobile terminal 286 through contactless power supply. Thus, if the mobile terminal 286 is the electronic device A, which provides contactless power supply and operates with the power stored in the power storage unit 282, transmitted power can be received and stored in the power storage unit 287 without connecting the mobile terminal 286 to the battery 280 using a cable. Accordingly, the mobile terminal 286 can be readily charged by placing the mobile terminal 286 on the second surface 241 of the lid body 231 without paying attention to the connection state between the mobile terminal 286 and the battery 280. Further, since a cable does not have to be carried, the convenience for the lid 230 is enhanced.

### Fourth Embodiment

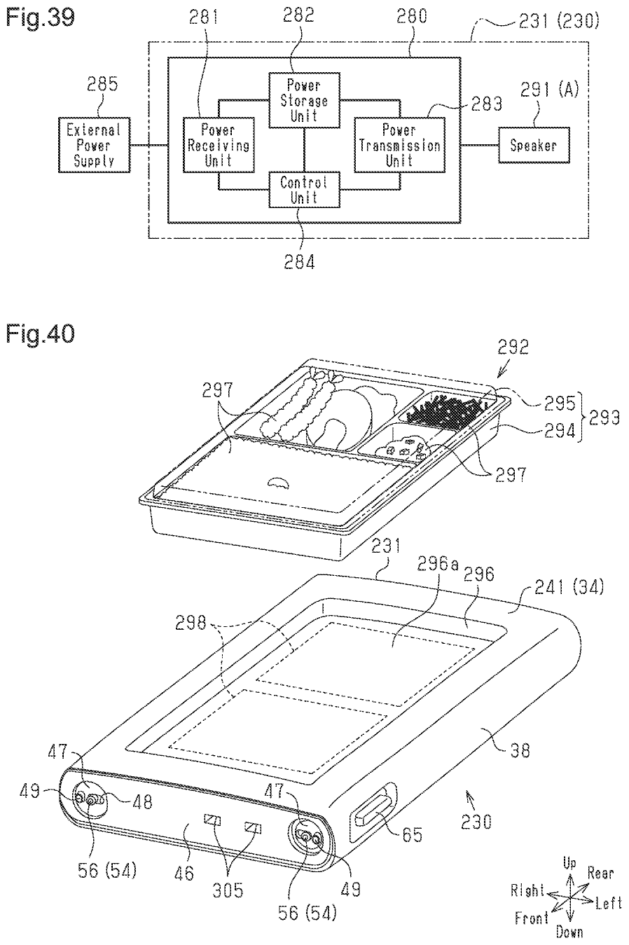

A console box according to a fourth embodiment will now be described with reference to FIGS. 38 and 39.

In the fourth embodiment, a speaker 291 is used as the electronic device A and is incorporated in the lid body 231. For example, the speaker 291 is attached to the lid body 231 in a state of being embedded in the front wall 43 and the front support plate 46 of the lid body 231. While FIG. 38 illustrates an example in which multiple (three) speakers 291 are used, the number of speakers 291 is not particularly limited. The speaker 291 may be, for example, a wireless speaker, a mobile speaker, a portable speaker. As shown in the power supply system of FIG. 39, the speaker 291 is electrically connected to the power transmission unit 283 of the battery 280 using a cable or the like. The speaker 291 is included in the power supply system together with the external power supply 285 and the battery 280.

The speaker 291 is connected to a terminal (e.g., a smartphone, a PC, or a tablet terminal) through wireless communication conforming to a short-range communication standard such as Bluetooth®, and outputs sound corresponding to sound source data such as music data sent from the terminal. The speaker 291 may send and receives sound source data via a wireless LAN.

Other than the above differences, the fourth embodiment is the same as the third embodiment. Thus, like or the same reference numerals are given to those components that are like or the same as the corresponding components described above in the third embodiment and detailed explanations are omitted.

The operation of the fourth embodiment will now be described.

In addition to the battery 280, the lid 230 includes, as its component, the speaker 291 electrically connected to the battery 280. The battery 280 functions as a power source of the speaker 291. The speaker 291 is operated by the power transmitted from the power transmission unit 283 of the battery 280 to provide its function. The speaker 291 outputs the sound corresponding to sound source data wirelessly communicated from the terminal.

### Advantages of Fourth Embodiment

Accordingly, the fourth embodiment has the following advantage in addition to the advantages similar to advantages (3-1) and (3-2).

(4-1) In the fourth embodiment, the battery 280 is accommodated in the lid body 231. The additional function portion includes the battery 280. In the fourth embodiment, the speaker 291 is incorporated in the lid 230. The battery 280 is electrically connected to the speaker 291 so that power is supplied from the battery 280 to the speaker 291. This allows the speaker 291 to output a sound corresponding to the sound source data sent from a terminal (e.g., a smartphone, a PC, or a tablet terminal). This advantage can be obtained either when the lid 230 is attached to the box body 11 or when the lid 230 is detached from the box body 11. In particular, the user can detach the lid 230 from the box body 11 and take it out of the vehicle to listen to sound source data (e.g., music data) recorded in the terminal as the sound output from the speaker 291.

### Modifications

The above embodiments may be modified as follows. The above embodiments and the following modifications can be combined as long as the combined modifications remain technically consistent with each other.

### Modifications Common to First to Fourth Embodiments

The upper opening 14 may be formed in a rectangular shape that is longer in the left-right direction than in the front-rear direction. In addition, on condition that the shape is rectangular, the shape of the upper opening 14 may be changed to a shape that is different from those of the first to fourth embodiments. Further, the shape of the upper opening 14 may be changed to a shape that is different from the rectangular shape.

The two pivot shafts 54 may be extended in the left-right direction instead of the front-rear direction.

One of the two pivot shafts 54 may be omitted so that the lids 30, 130, 230 may each be changed to a single-door type lid. In this case, the lock mechanism 60 (the first lock mechanism 60 in the second embodiment) corresponding to the pivot shaft 54 that is subject to omission is omitted.

To pivotally couple each of the lid bodies 31, 131, 231 to the box body 11, the opposite ends of the pivot shaft 54 in the front-rear direction need to have a shaft shape extending in the front-rear direction. Thus, the entire pivot shaft 54 may have a shaft shape as a whole as in the above embodiments. An intermediate portion of the pivot shaft 54 in the front-rear direction does not need to have a shaft shape.

The lock mechanism 60 (the first lock mechanism 60 in the second embodiment) may lock the lid 30, 130, 230 with the upper opening 14 closed without using the shim 70.

For example, each pivot shaft 54 may be divided into two shafts in the front-rear direction. The two shafts include a first shaft having a cylindrical first end and a second shaft having a cylindrical second end. The first shaft and the second shaft are biased away from each other in the front-rear direction by a spring provided therebetween.

Each of the front and rear support walls 21 of the box body 11 includes a tubular bearing having a closed end, instead of the shim accommodating portion 22. The first end and the second end of each pivot shaft 54 are accommodated in a corresponding bearing. The first end and the second end are pivotally supported by each bearing.

Furthermore, an interlock mechanism is disposed between the operation portion 65 and the first and second shafts. The interlock mechanism moves the two shafts in a direction in which the two shafts move toward each other in the front-rear direction, in conjunction with the inward movement of the operation portion 65 in the left-right direction.

In this case, the first end and the second end can be removed from the bearing by pushing the operation portion 65 so that the pivot shaft 54 can be decoupled from the support wall 21 (the box body 11).

The lid 30, 130, 230 may be detachable from the box body 11 even when the two operation portions 65 are not simultaneously operated. For example, one of the operation portions 65 is operated to decouple the corresponding pivot shaft 54 from the support wall 21. After the decoupling, the other operation portion 65 is operated to decouple the corresponding pivot shaft 54 from the support wall 21. As a result, the two pivot shafts 54 are both decoupled from the support wall 21 so that the lid 30, 130, 230 becomes detachable.

The operation portion 65 is not limited to one that is operated to be pushed inward in the left-right direction, and may be of a tiltable lever type. In this case, the operation portion 65 may be located in the box body 11 instead of the lid body 31, 131, 231. A conversion mechanism is disposed between the operation portion 65 and the pivot shaft 54.

When receiving a force that tilts the operation portion 65, the conversion mechanism converts the force into a force that moves the pivot shaft 54 inward in the left-right direction.

### Modification of First Embodiment

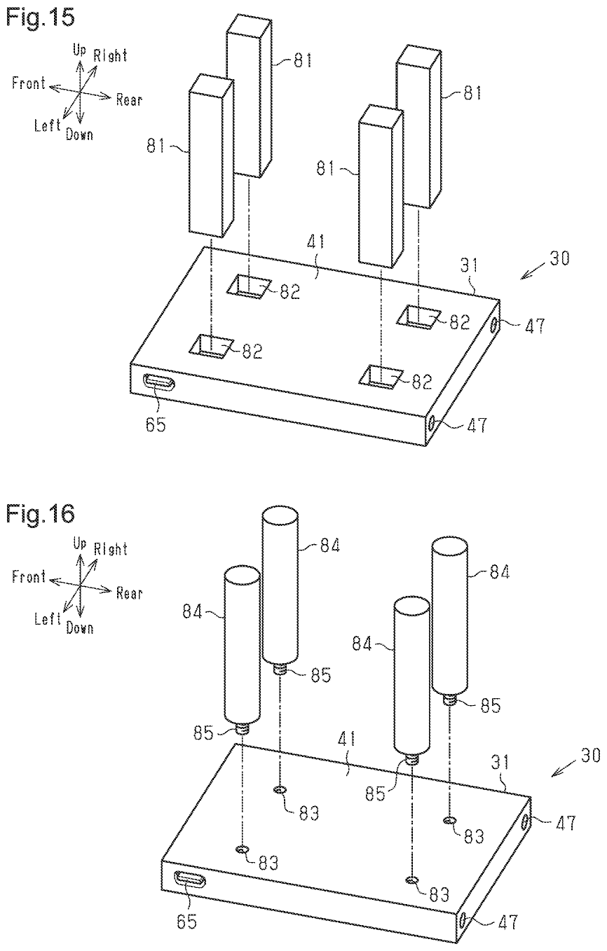

As illustrated in FIG. 15, the storage recess 80 and the legs 81 may be omitted from the lid 30. Instead, the second surface 41 of the lid 30, which is one surface in the thickness direction of the lid body 31, may have a fitting recess 82 as an example of an attachment portion to which each leg 81 is removably attached. In the lid 30 of this example, the second surface 41 of the lid body 31 has four rectangular fitting recesses 82. One end of each leg 81 is fitted to a corresponding fitting recess.

In this case, the four fitting recesses 82 are arranged in a well-balanced manner to surround the central portion of the second surface 41. That is, the four fitting recesses 82 are disposed on the second surface 41 of the lid body 31 so that the lid body 31 is supported in a well-balanced manner by the four legs 81 when the legs 81 are respectively fitted into the four fitting recesses 82.

This configuration allows the lid 30 to be used as a chair, a table, or the like by respectively fitting and attaching four separately-prepared legs 81 to the four fitting recesses 82 of the lid body 31 with the lid 30 detached from the box body 11. Thus, the fitting recesses 82 (attachment portions) enable the user to use the lid 30 in a manner different from the opening and closing of the upper opening 14. Accordingly, the fitting recess 82 (attachment portion) corresponds to the additional function portion in the modification of FIG. 15.

As shown in FIG. 16, in the lid 30 of FIG. 15, female screw holes 83 may each be employed as an example of the attachment portion instead of the fitting recess 82. In this case, the legs 81 may be changed to, for example, columnar legs 84, and male screw portions 85 configured to be respectively fastened to the female screw holes 83 may each be provided on one end surface of the leg 84.

In this configuration, in a state in which the lid 30 is detached from the box body 11, the male screw portions 85 of four separately-prepared legs 84 can be fastened and attached to the four female screw holes 83 of the lid body 31, respectively. Thus, the lid 30 can be used as a chair, a table, or the like. Accordingly, the female screw hole 83 (attachment portion) corresponds to the additional function portion in the modification of FIG. 16.

The surface of the lid body 31 on the side opposite to the legs 81 does not have to be made of a material softer than that of the surface of the lid body 31 where the legs 81 are disposed.

The storage recesses 80 may be omitted.

The number of the legs 81 may be changed. In this case, the thickness and arrangement of the legs 81 are set according to the number of the legs 81 so that the lid body 31 can be stably supported by the legs 81.

A battery may be incorporated in the lid body 31. This configuration allows the battery to supply power to the external device.

### Modification of Second Embodiment

The mirror 188 may be omitted.

At least one of the first surface 34 and the second surface 141 of the lid 130 may be defined by the covering 37. That is, as in the second embodiment, only the first surface 34 of the lid 130 may be defined by the covering 37, only the second surface 141 of the lid 130 may be defined by the covering 37, or the first surface 34 and the second surface 141 of the lid 130 may be defined by the covering 37.

The second lock mechanism 186 may be omitted.

The second storage 181 may store, for example, an emergency kit, a cooking set for camping, fishing goods, or the like.

The lid member 182 may be a double-leaf lid member or a slidable lid member.

The lid member 182 may be attachable to and detachable from the lid body 131.

### Modification Common to Third Embodiment and Fourth Embodiment

The second halved body 239 may have a layer structure similar to that of the first halved body 33. That is, the second halved body 239 includes a base formed of a hard resin material, a cushion layer laminated on the base and formed of a foam, and a covering laminated on the cushion layer.

In the same manner as the second halved body 239, the entire first halved body 33 may be formed of a hard resin material.

At least one of the first halved body 33 and the second halved body 239 may have a layer structure including a base formed of a hard resin material and a covering directly laminated on the base without a cushion layer disposed therebetween.

There may be only one recess 240 (refer to FIG. 34) or multiple recesses 240 in the second halved body 239. Further, the recess 240 may be omitted from the second halved body 239. In this case, the first surface 34 and the second surface 241 have no recess 240 and thus have a similar appearance. However, the first surface 34 and the second surface 241 may have different design keynotes.

A push-up mechanism that pushes up the lid 230 from the box body 11 in response to the release of lock by the lock mechanism 60 may be added. In this case, by releasing the lock, a part of the lid 230 can be protruded upward from the box body 11 by the push-up mechanism.

When one of the operation portions 65 is pushed, the pivot shaft 54 corresponding to the operation portion 65 is decoupled from the box body 11. The pivot shaft 54 corresponding to the operation portion 65 that has not been pushed remains coupled to the box body 11. In this case, by gripping the portion of the lid 230 that protrudes from the box body 11, the lid 230 is readily pivoted about the pivot shaft 54 that remains coupled so that the upper opening 14 can be opened and closed. This provides a preferred operability of the lid 230.

In addition, when the two pivot shafts 54 are decoupled from the box body 11, the lid 230 can be readily detached from the box body 11 by gripping the portion of the lid 230 protruding from the box body 11.

Further, the push-up mechanism is expected to provide the following advantage. If the pushing operation of the two operation portions 65 is cancelled and the two operation portions 65 are then coupled to the box body 11 again, the lid 230 cannot be detached from the box body 11. The push-up mechanism prevents such detachment.

### Modification of Third Embodiment

The battery 280 may receive the power supplied from the external power supply 285 through contactless power supply and store the power in the power storage unit 282.

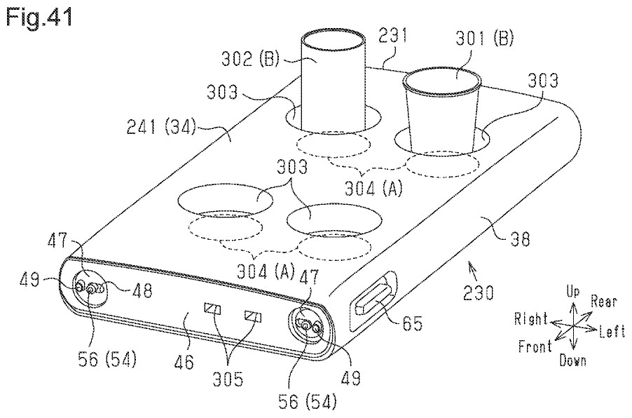

In addition to, or instead of the configuration of the third embodiment, as illustrated in FIGS. 40 and 41, a connector 305 (e.g., a USB connector) connected to the power transmission unit 283 may be disposed at any position of the lid body 231 (e.g., at the support plate 46 or the side wall 38). The electronic device A including the power storage unit 287 may be connected to the connector 305 using a USB cable. In other words, power supply from the battery 280 to the electronic device A may be performed through USB power supply, in which power is supplied through a USB cable. Then, the power storage unit 287 may be charged with the power supplied to the electronic device A.

### Modification of Fourth Embodiment

In the fourth embodiment, the electronic device A that is of a type different from the speaker 291 may be incorporated in the lid body 231. Examples of the electronic device A include a light, a mobile router, a warmer, a cooler, a humidifier, an air cleaner, a projector, and a Blu-ray® disk drive, a hard disk player, and a tablet terminal. However, these are merely examples, and another device may be used as the electronic device A.

Any type of the electronic device A is electrically connected to the power transmission unit 283 of the battery 280 using a cable or the like. Any type of the electronic devices A is supplied with power through the power transmission unit 283 to provide the function of the electronic device A.

Examples of the light include an LED light using an LED as a light source. In this case, the light may brighten the surroundings with the lid 230 attached to the box body 11, or may brighten the surroundings with the lid 230 detached from the box body 11. In the former case, the light is coupled to a portion exposed from the lid body 231 attached to the box body 11 (e.g., the left and right side walls 38 of the lid body 231). In the latter case, the light may be coupled to any portion. In the latter case, the lid 230 can be used as a flashlight for emergency or disaster prevention.

Lights may be used in one lid 230. In this case, each light that emits light beams of different colors may be used, and the lights may be operated in irradiation patterns each having a different intensity, color, irradiation time, and the like.

A mobile router is a communication terminal small enough to be carried by the user. The mobile router obtains a terminal identifier of an ID card from a mobile communication terminal (e.g., a smartphone or a tablet terminal) through wireless LAN communication to check the terminal identifier with a terminal identifier of an ID card held by the mobile router and authenticate the mobile communication terminal. When the authentication is successful, the mobile router connects the mobile communication terminal to a network through wide-range communication.

Examples of the mobile router include a mobile Wi-Fi® router. In this case, Wi-Fi® can be used in a vehicle. Also, Wi-Fi® allows the user to access the Internet network as an external network even while away from home. Further, by detaching the lid 30 from the box body 11 and taking it out of the vehicle, the user can use Wi-Fi® anywhere outside the vehicle at any time. Furthermore, the use of one mobile router allows mobile communication terminals located around the mobile router to be simultaneously connected to the Internet network.

FIG. 40 shows the lid 230 in which a warmer 298 that keeps a boxed meal 292 warm is incorporated in the lid body 231. A meal container 293 of the boxed meal 292 includes a container body 294 having an upper end opening and storing food 297, and a door body 295 covering the upper end opening of the container body 294. In FIG. 40, the door body 295 is illustrated by the long dashed double-short dashed line.

The lid body 231 has a recess 296 that opens in one of the second surface 241 and the first surface 34. The recess 296 is sized and shaped so as to accommodate at least a lower portion of the container body 294. In the lid body 231, warmers 298 each including a Peltier element are disposed at positions that are deeper than a bottom surface 296a of the recess 296 and are relatively close to the bottom surface 296a. The Peltier element is a plate-like semiconductor element utilizing the Peltier effect, in which heat is transferred from one of two types of metals metal to the other when current is passed through a junction between the two metals. When DC current is passed through the Peltier element, one surface of the element absorbs heat and the other generates heat. Reversing the polarity of the current reverses the endothermic and exothermic relationship. The warmers 298 are incorporated into the lid body 231 with a heat generating surface of the Peltier element facing upward.

For example, when the boxed meal 292 purchased in a heated state at a convenience store is brought into the passenger compartment, the boxed meal 292 gradually cools down if left untouched during driving of the vehicle. However, the energization of the Peltier elements in the warmers 298 causes the upper surface (heating surface) of the Peltier element to generate heat. At least the lower portion of the container body 294 that accommodates the food 297 is placed and accommodated in the recess 296 of the lid body 231. Then, the heat generated by the warmers 298 is transferred to the food 297 in the meal container 293 through the container body 294. This keeps the boxed meal 292 warm during driving of the vehicle.

In addition, since the boxed meal 292 is kept warm with at least the lower portion of the container body 294 accommodated in the recess 296, the boxed meal 292 is prevented from being displaced from a position above the warmers 298.

FIG. 41 illustrates the lid 230 incorporating a cooler 304 that cools a container (beverage container B) containing beverage, such as a cup 301 and a beverage can 302. The lid body 231 has recesses 303 that open in one of the second surface 241 and the first surface 34. In FIG. 41, recesses 303 each having a circular opening are located at positions spaced apart from each other on the second surface 241 or the first surface 34. Each recess 303 is sized and shaped so as to accommodate at least a lower portion of the beverage container B.

In the lid body 231, the coolers 304 each including a Peltier element are disposed at positions that are deeper than a bottom surface of the recess 303 and are relatively close to the bottom surface. The coolers 304 are incorporated in the lid body 231 with a heat absorbing surface of the Peltier element facing upward.

The lid 230 functions as a cup holder. By accommodating at least the lower portion of the beverage container B in the recess 303, the beverage container B can be held in an standing state.

In addition, when the beverage container B containing cool beverage is brought into the vehicle and accommodated in the recess 303, the temperature of the beverage rises as time elapses. However, the energization of the Peltier elements causes the upper surface (heating surface) of the Peltier element to absorb heat. This limits a rise in the temperature of the beverage container B, keeping the beverage cool.

The upper surface of the Peltier element may be heated by changing the direction of the current flowing through the Peltier element. In this case, the beverage container B is kept warm. By switching the direction of the current flowing through the Peltier element depending on the situation, the upper surface of the Peltier element generates heat to keep the beverage container B warm or absorbs heat to keep the beverage container B cold.

A humidifier is a device that discharges the moisture vaporized or atomized by a humidifying means from an outlet. The humidifier is incorporated in the lid body 231 with the outlet exposed.

There are roughly four types of humidification methods of humidifiers. The methods include a steam method, an ultrasonic method, a vaporization method, and a hybrid method. The steam method is a humidification method in which water is heated by a heater to be boiled into steam. The ultrasonic method is a humidification method in which water is atomized by vibration of ultrasonic waves and discharged into the air by a built-in fan. The vaporization method is a humidification method in which air is blown to a filter containing water by a fan to generate water vapor. The hybrid method is a method in which two different types of the humidification systems are combined. For example, the hybrid method is a humidification system in which the steam system and the vaporization system are combined or a humidification system in which the steam system and the ultrasonic system are combined. A humidifier with any of the humidification methods may be incorporated in the lid body 231 as the electronic device A.

Utilizing the humidifier to humidify the air in a confined space, such as a vehicle interior, allows for the maintenance of humidity in a person's immediate surroundings. Using the humidifier can also be effective in combating allergies, such as hay fever and in virus prevention. This is primarily because it prevents the nose and throat from drying out, which in turn can help maintain the barrier function of the mucous membranes. The barrier function refers to the ability of the mucous membranes in the respiratory tract, such as the nose and throat, to expel foreign substances like pollen and viruses along with mucus. Additionally, maintaining an appropriate level of humidity inside the vehicle can help suppress the dispersal of pollen that has entered the vehicle.

An air cleaner is a device that cleanses the air by capturing or removing particulate matter, pollen, influenza viruses, and the like. Air purifiers include an ion generation type, a filter type, and a hybrid type.

The ion generation type releases ions to capture and decompose floating bacteria. This type has high deodorizing performance, and thus removes floating bacteria that cause odors of tobacco, mold, and the like. In addition, this type has an advantage of charging and dropping dust floating in the vehicle or weakening bacteria. The filter type draws in substances floating in the air together with the air, filters them using a filter, and then discharges them as clean air. Fine particles such as pollen, PM2.5 and allergen substances can be trapped. The hybrid type is a combination of the ion generation type and the filter type, and has a high air cleaning power and a high deodorizing power. Any type of air cleaner may be incorporated in the lid body 231 as the electronic device A.

The projector is one type of display device that displays images and videos, and is incorporated in the lid body 231 with its lens exposed.

In this case, another electronic device (e.g., a smartphone or a tablet terminal) is electrically connected to the projector in an indirect manner through wireless transmission. The projector receives an image signal from a smartphone or the like, enlarges the image, and projects the enlarged image on a screen, a wall, or the like.

By detaching the lid 230 in which the projector is incorporated in the lid body 231 from the box body 11 and taking it out of the vehicle, the user can watch videos or the like anytime and anywhere.

A Blu-ray® disc drive is a disc drive supporting playback and recording of a Blu-ray® disc among optical disc drives. The Blu-ray® disc is a standard for an optical disc that reads and writes data using a blue-violet semiconductor laser. The blue-violet laser has an extremely short wavelength of light. Thus, the Blu-ray® disc can record data at a track pitch that is half or less of that of a DVD, which is another standard of an optical disc, and has a larger storage capacity than a DVD.

A hard disk player is one type of digital audio player that is an audio device capable of recording and reproducing digital data of music, and uses a hard disk as a storage device. The hard disk player functions to record, on a built-in hard disk, music data downloaded from a music distribution service on the Internet or captured from a CD and reproduce the music data. Some hard disk players are capable of recording and reproducing not only music but also videos, still images and the like.

A tablet terminal is a plate-shaped display-integrated PC, and is a portable information terminal including a touch panel as an input/output device. The touch panel is an electronic component having an input function and a display function. The touch panel displays information, receives an input from a user, and the like. The display function is performed by a display device (e.g., a liquid crystal display). The input function is performed by a sensor or the like that detects contact of an object (e.g., a user's finger, a dedicated pen, or a general pen) that contacts a contact surface (front surface) of the display device. The method for detecting the contact of a contact object may be any known method (e.g., an electrostatic method, a resistive film method, or an optical method).

Various applications (e.g., a network browser function and an email function) can be executed by touching the touch panel with a finger, a pen, or the like to perform an operation. For example, map information, road information, or the like can be displayed in real time, and information existing on the Internet network can be searched simply when necessary.

In any of the above examples, the lid 230 includes, in addition to the battery 280, the electronic device A that is electrically connected to the battery 280 as a part of the lid 230. In this case, the battery 280 functions as a power supply of the electronic device A. The electronic device A is operated by the power transmitted from the power transmission unit 283 of the battery 280, and provides its function.

Each type of the electronic device A has a different function. Accordingly, the function achieved by the lid 230 varies depending on the type of the electronic device A incorporated in the lid 230. In other words, various functions are achieved by the lid 230 by using different types of the electronic device A incorporated in the lid 230.

If the electronic device A is of a type that uses contactless power supply and operates with the power stored in the power storage unit 282, the various electronic devices A exemplified as described above can be used as the electronic device A (mobile terminal 286) in the third embodiment.

Interior Structure for Vehicle

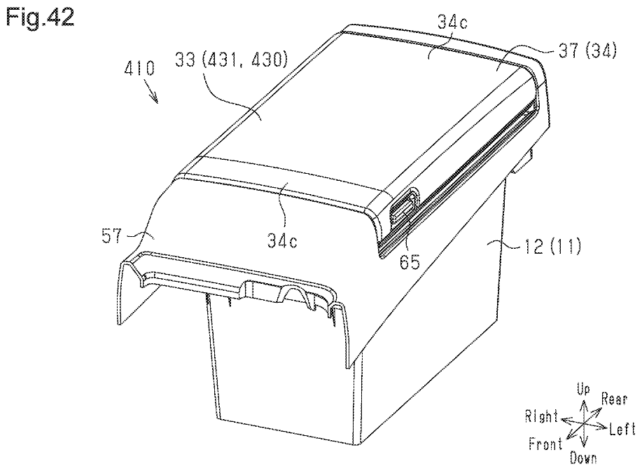

An embodiment of an interior structure for a vehicle that includes a console box 410 will now be described with reference to FIGS. 42 to 51.

The interior structure for the vehicle includes the console box 410 shown in FIG. 42 and a door trim 480 as an example of a vehicle interior component shown in FIG. 51. The door trim 480 is a vehicle interior component that is different from the console box 410, and is disposed on the inner side of a door (not shown) of the vehicle. The same components of the console box 410 as those of the console box 10 of the first embodiment are denoted by the same reference numerals. A lid 430, a lid body 431, a second halved body 439, and a second surface 441 of the console box 410, which will be described later, correspond to the lid 30, the lid body 31, the second halved body 39, and the second surface 41 of the first embodiment, respectively. Thus, in the description of the console box 410, the description overlapping with the description of the console box 10 of the first embodiment will be omitted.

Console Box 410

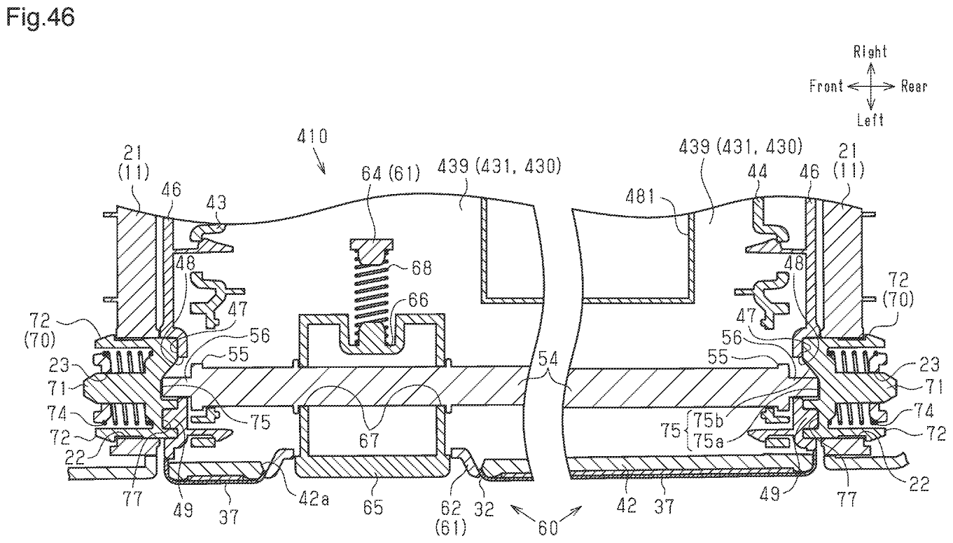

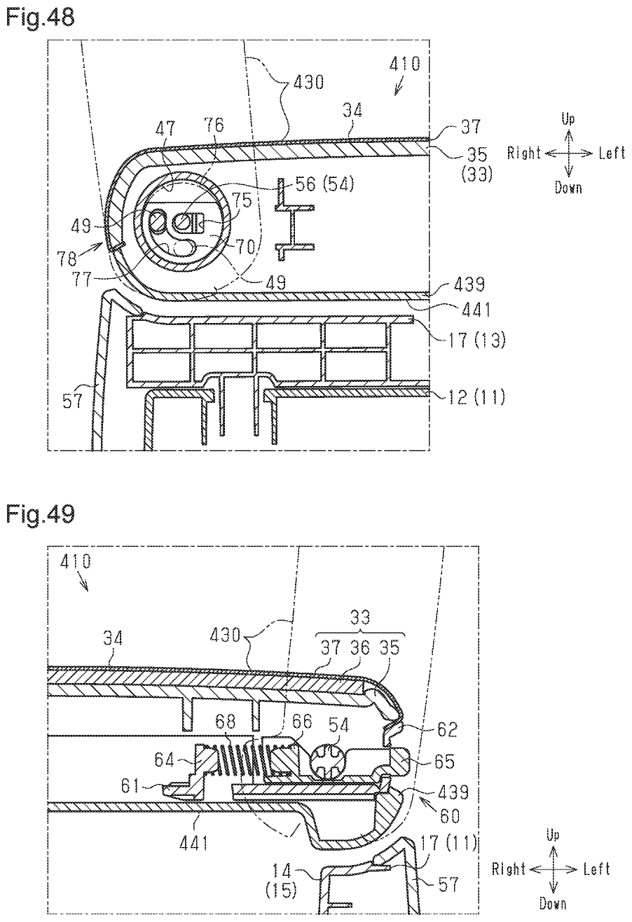

FIG. 42 shows the main section of the console box 410. In the same manner as the console box 10 of the first embodiment, the console box 410 is a part of the center console disposed between the driver's seat and the passenger seat in a passenger compartment. The console box 410 includes the box body 11, the lid 430, the housing 57, the lock mechanism 60 (see FIG. 46), and the pivot range defining portion 78 (see FIG. 48).

Box Body 11

The box body 11 of the console box 410 has a configuration similar to that of the box body 11 (see FIGS. 2 to 5) of the console box 10 of the first embodiment. Thus, the box body 11 will not be described in detail.

Lid 430

As shown in FIG. 42, the lid 430 is detachably coupled to the box body 11. In a state in which the lid 430 is coupled to the box body 11, the lid 430 is pivotal between the closed position, at which the lid 430 closes the upper opening 14 as indicated by the solid line in FIG. 49, and the fully-open position, at which the lid 430 is raised to fully open the upper opening 14 as indicated by the long dashed double-short dashed line in FIG. 49. In other words, the lid 430 opens and closes the upper opening 14 by pivoting between the closed position and the fully-open position. Thus, the lid 430 with the upper opening 14 closed will hereinafter be described.

Basic Structure of Lid 430

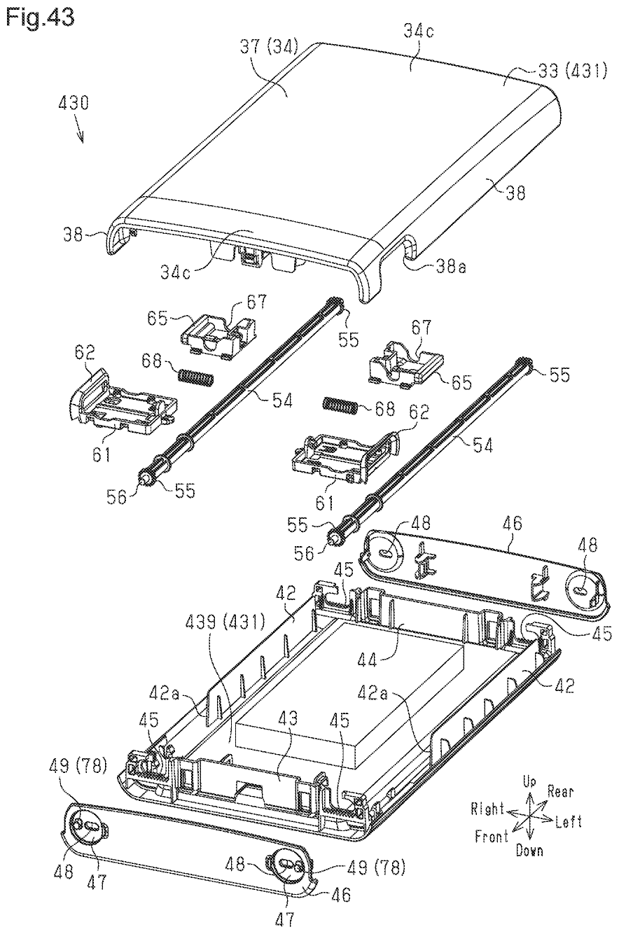

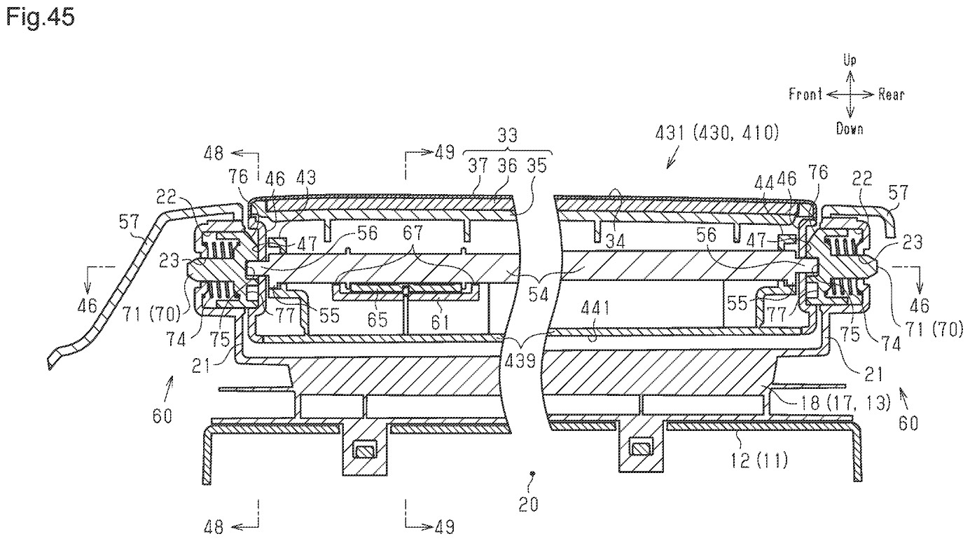

As shown in FIG. 43, the lid 430 includes the lid body 431, the two support plates 46, and the two pivot shafts 54. The lid body 431 is shaped and sized so as to close the upper opening 14 from above. The up-down direction of the lid body 431 is the thickness direction of the lid body 431. The lid body 431 includes the first halved body 33 on one side in the thickness direction and a second halved body 439 located on the other side and joined to the first halved body 33. FIG. 45 illustrates the lid 430 with the first halved body 33 located above the second halved body 439.

As shown in FIG. 45, the first halved body 33 includes the base 35, which is formed of a hard resin material, the cushion layer 36, which is laminated on the base 35 and formed of a foam, and the covering 37, which is laminated on the cushion layer 36. The portion of the covering 37 that is a surface of the lid 430 on one side in the thickness direction is the first surface 34 of the lid 430. That is, the first surface 34, which is one of the surfaces of the lid 430 in the thickness direction, is defined by the covering 37. At least a part of the first surface 34 of the lid 430 has an armrest surface. In the present embodiment, the entire first surface 34 is the armrest surface.

The entire second halved body 439 is formed of a hard resin material. The surface of the second halved body 439 on the opposite side (back side) to the first surface 34 in the thickness direction is the second surface 441 of the lid 430.

As shown in FIG. 43, the first halved body 33 includes the two side walls 38 in the left-right direction, and the front part of each side wall 38 has a corresponding notch 38a. Similarly, the second halved body 439 includes the two side walls 42 in the left-right direction, and the front part of each side wall 42 has a corresponding notch 42a. When the second halved body 439 is joined to the first halved body 33, the notches 38a, 42a form an operation hole 32 as shown in FIG. 46.

As shown in FIG. 43, the two support plates 46 are disposed on the opposite outer sides of the lid body 431 in the front-rear direction, respectively. The front support plate 46 is attached to the front wall 43 of the second halved body 439. The rear support plate 46 is attached to the rear wall 44 of the second halved body 439. The outer surface of each support plate 46 in the front-rear direction is a part of a side surface of the lid 430.

As shown in FIG. 45, the box body 11 and the lid 430 are shaped such that the lid 430 is detachable from and couplable to the box body 11 regardless of whether the first surface 34 or the second surface 441 of the lid 430 is oriented upward.

The two pivot shafts 54 function to pivotally couple the lid body 431 to the box body 11. As shown in FIG. 43, the pivot shafts 54 extend in the front-rear direction in parallel with each other on the opposite side portions of the lid body 431 in the left-right direction. The lid 430 is pivotable between the closed position and the fully-open position about one pivot shaft 54 selected from the two pivot shafts 54.

The pinion gears 55 are respectively disposed on the outer circumferences of the opposite ends of each pivot shaft 54 in the front-rear direction. The rack gears 45 are respectively disposed on the opposite side portions of each of the front wall 43 and the rear wall 44 of the second halved body 439 in the left-right direction. The pinion gear 55 at the front end of each pivot shaft 54 is meshed with the rack gear 45 of the front wall 43, and the pinion gear 55 at the rear end of each pivot shaft 54 is meshed with the rack gear 45 of the rear wall 44.

Each pivot shaft 54 includes a corresponding pin 56, which extends in the front-rear direction, on the outer side of the pinion gear 55 in the front-rear direction. The recesses 47 recessed inward in the front-rear direction are respectively disposed at the left and right side portions of each of the front and rear support plates 46. The bottom of each recess 47 has the elongated hole 48 that extends through the support plate 46 in the left-right direction. The pin 56 of each pivot shaft 54 is inserted through a corresponding elongated hole 48.

The lid 430 can pivot integrally with any one of the pivot shafts 54. The pinion gear 55 can roll on the rack gear 45. Each elongated hole 48 allows the pin 56 to move in the left-right direction, and defines the range of movement of the pin 56 in the left-right direction.

Housing 57

As shown in FIGS. 42 and 45, the housing 57 accommodates the box body 11 with the upper surface and the side surface of the lid 430 exposed. FIG. 42 shows only a part of the housing 57.

Lock Mechanism 60

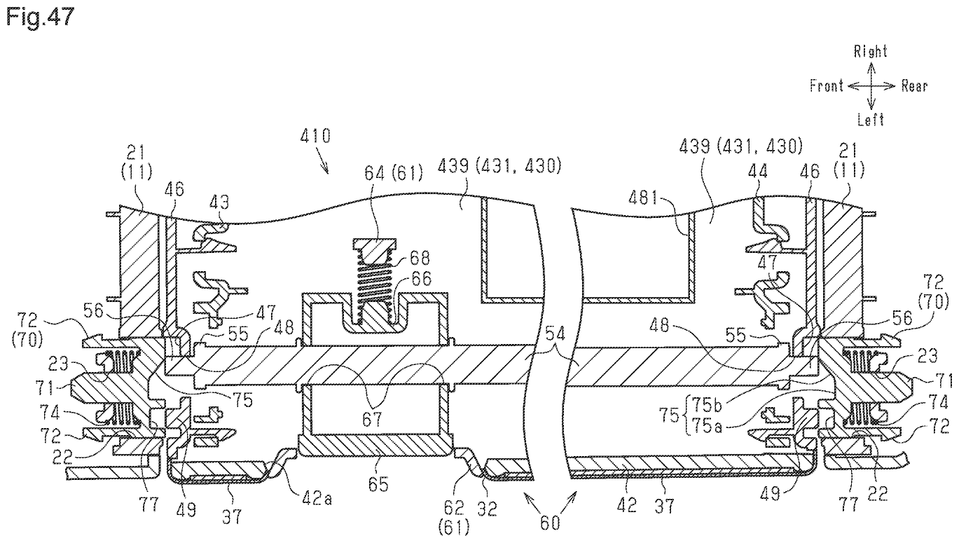

As shown in FIGS. 46 and 47, the lock mechanism 60 functions to lock the lid 430 in a state in which the upper opening 14 is closed (i.e., lock the lid 430 at the closed position) and unlock the lid 430. The lock mechanism 60 also functions to switch between a coupled state in which each pivot shaft 54 is coupled to the box body 11 and a state in which they are decoupled from each other.

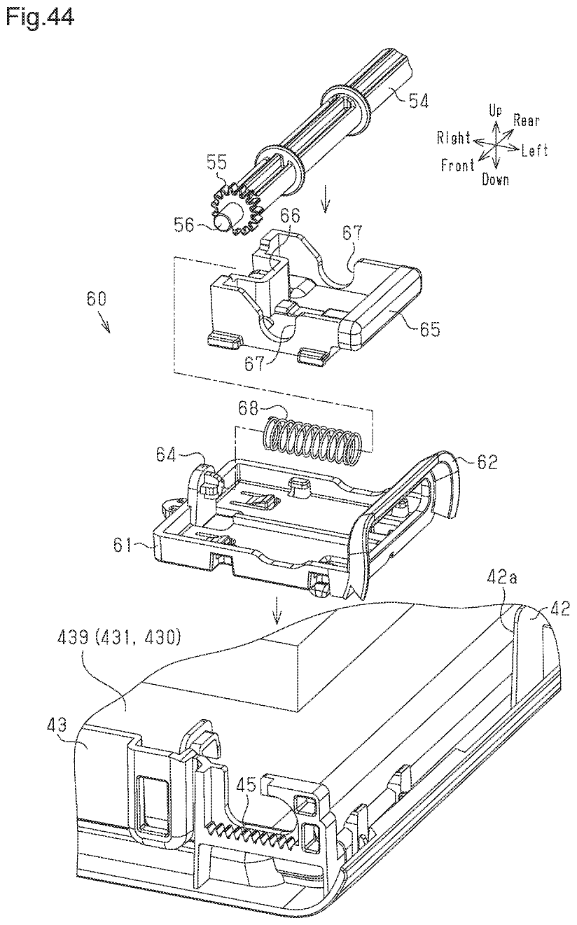

As shown in FIG. 44, the lock mechanism 60 of the console box 410 has a configuration similar to that of the lock mechanism 60 (see FIG. 7) of the console box 10 in the first embodiment. Thus, the lock mechanism 60 will not be described in detail.

In the same manner as the shims 70 of the console box 10 in the first embodiment, each shim 70 of the console box 410 functions to pivotally support a corresponding pivot shaft 54 in a state in which the end of the pivot shaft 54 is coupled to the box body 11. Thus, the shims 70 are included in the shaft support that pivotally supports the lid 430 at the pivot shaft 54.

Pivot Range Defining Portion 78

The pivot range defining portion 78 defines the pivot range of the lid 430 such that the lid 430 pivots between the closed position and the fully-open position, which have been described above. As shown in FIG. 48, the pivot range defining portion 78 of the console box 410 has a configuration similar to that of the pivot range defining portion 78 (see FIG. 11) of the console box 10 in the first embodiment. Thus, the pivot range defining portion 78 will not be described in detail.

Configuration of Lid 430 on Second Surface 441

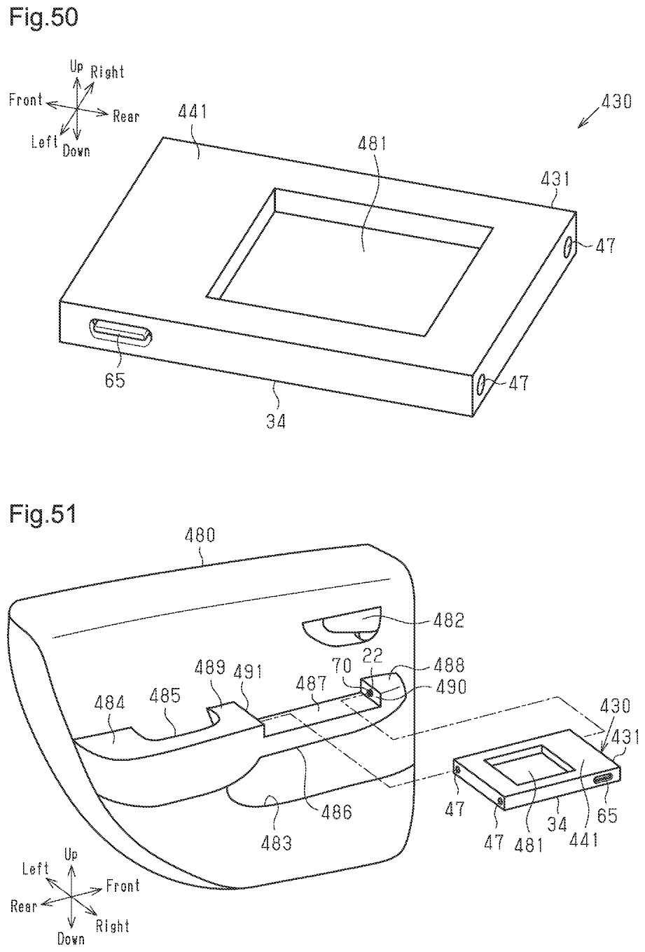

As shown in FIG. 50, a tray portion 481 as an example of the function portion is recessed in a substantially central portion of the second surface 441 of the lid body 431 in the lid 430. The tray portion 481 has a rectangular shape in which the long side direction coincides with the front-rear direction. The tray portion 481 functions as a tray on which fast food (e.g., French fries and chicken nuggets, beverage containers, or small items) can be placed.

Door Trim 480

As shown in FIG. 51, an interior door handle 482 is disposed at an upper front part of the inner surface of the door trim 480. A door pocket 483 is disposed at a lower part of the inner surface of the door trim 480. An armrest 484 that extends in the front-rear direction is disposed at a rear central portion of the inner surface of the door trim 480 in the up-down direction. A handle portion 485 is recessed in the upper surface of the armrest 484.

As shown in FIGS. 50 and 51, a lid coupling portion 486 is disposed at a position on the front side of the armrest 484 on the inner surface of the door trim 480. The lid coupling portion 486 extends in the front-rear direction and is detachably coupled to the lid 430. The lid coupling portion 486 and the armrest 484 are integrally formed. The lid coupling portion 486 includes a base 487 that extends straight forward from a front end of the armrest 484, a base front wall 488 that is arranged upright on a front end of the base 487, and a base rear wall 489 that is defined by the front end of the armrest 484.

The upper surface of the base 487 is flat, and is lower than the upper surface of the base front wall 488 and the upper surface of the base rear wall 489. The length of the upper surface of the base 487 in the front-rear direction is slightly longer than the length of the lid 430 in the long side direction. Further, the length of the upper surface of the base 487 in the left-right direction is about half the length of the lid 430 in the short side direction. A rear surface 490 of the base front wall 488 and a front surface 491 of the base rear wall 489 are flat surfaces, and face each other in the front-rear direction.

As shown in FIGS. 45, 50, and 51, in the same manner as the box body 11, the rear surface 490 of the base front wall 488 and the front surface 491 of the base rear wall 489 respectively have the shim accommodating portions 22 so as to face each other in the front-rear direction. In the same manner as the box body 11, the shim 70 and the second spring 74 are coupled to each shim accommodating portion 22.

In the same manner as the box body 11, each shim 70 functions to detachably couple the end of one of the two pivot shafts 54 of the lid 430 to the lid coupling portion 486 of the door trim 480. That is, the lid coupling portion 486 of the door trim 480 includes the shims 70 that pivotally support the lid 430 at the pivot shaft 54. Thus, the lid 430 that has been detached from the box body 11 is detachably coupled to the lid coupling portion 486 of the door trim 480. In the door trim 480, the shims 70 are included in the shaft support that pivotally supports the lid 430 at the pivot shaft 54.

Next, the operation of the console box 410 will be described. As described above, the same components of the console box 410 as those of the console box 10 of the first embodiment are denoted by the same reference numerals. The lid 430, the lid body 431, the second halved body 439, and the second surface 441 respectively correspond to the lid 30, the lid body 31, the second halved body 39, and the second surface 41 of the first embodiment. Thus, the description of the operation overlapping with that of the console box 10 of the first embodiment will be omitted.

When None of Operation Portions 65 is Pushed

The operation gained when none of the operation portions 65 is pushed is the same as operation described in the section “When None of Operation Portions 65 is Pushed” in the console box 10 of the first embodiment. Thus, in the present embodiment, the detailed description is omitted.

When One Operation Portion 65 is Pushed

The operation gained when one of the operation portions 65 is pushed is the same as operation described in the section “When One Operation Portion 65 is Pushed” in the console box 10 of the first embodiment. Thus, in the present embodiment, the detailed description is omitted.

When Two Operation Portion 65 are Simultaneously Pushed

The operation gained when the two operation portions 65 are simultaneously pushed is the same as operation described in the section “When Two Operation Portion 65 are Simultaneously Pushed” in the console box 10 of the first embodiment. Thus, in the present embodiment, the detailed description is omitted.

When Lid 430 is Attached to Box Body 11

The operation gained when the lid 430 is attached to the box body 11 is the same as the operation described in the section “When Lid 30 is Attached to Box Body 11” of the first embodiment. Thus, in the present embodiment, the detailed description is omitted.

Next, the operation gained when the lid 430 detached from the box body 11 is coupled to the door trim 480 and used by the user will be described.

As shown in FIGS. 45 and 51, when the lid 430 detached from the box body 11 is coupled to the door trim 480 for use, the user first moves the lid 430 so that the second surface 441 faces upward. Subsequently, in the same manner as the section “When Lid 430 is Attached to Box Body 11” (i.e., in the same manner as the section “When Lid 30 is Attached to Box Body 11” of the console box 10 of the first embodiment), the user moves the front and rear pins 56 of one pivot shaft 54 of the lid 430 into the accommodating recesses 75 of the front and rear shims 70 of the lid coupling portion 486 of the door trim 480, respectively.

As a result, with the second surface 441 facing upward, the lid 430 is pivotally supported by the front and rear shims 70 of the lid coupling portion 486 of the door trim 480 at the pivot shaft 54. That is, the lid 430 is coupled to the lid coupling portion 486 of the door trim 480. This causes a part of the first surface 34 of the lid 430 to be supported from below by the upper surface of the base 487. Thus, the lid 430 is held at a substantially horizontal position with the second surface 441 facing upward.

The second surface 441 of the lid 430 has the tray portion 481, which functions when the lid 430 is coupled to the lid coupling portion 486 of the door trim 480. Thus, the tray portion 481 is used as a tray on which fast food (e.g., French fries or chicken nuggets), beverage containers, or small items can be placed. That is, the function of the tray portion 481 of the lid 430 can be provided not only on the box body 11 but also on the door trim 480.

### Advantages of Embodiment

The embodiment described above in detail has the following advantages.

(1) The interior structure for the vehicle includes the console box 410, which includes the box body 11 having the storage 20 with the upper opening 14 and includes the lid 430 detachably coupled to the box body 11 to open and close the upper opening 14, and the door trim 480, to which the lid 430 detached from the box body 11 is detachably coupled. The lid 430 includes the tray portion 481, which functions when coupled to the door trim 480.

In this configuration, the upper opening 14 of the storage 20 is opened and closed by, for example, pivoting the lid 430 that is coupled to the box body 11. Further, the upper opening 14 is opened when the lid 430 is detached from the box body 11.

When the upper opening 14 is opened, an article outside the storage 20 can be stored in the storage 20 through the upper opening 14. This also allows the article stored in the storage 20 to be taken out of the storage 20 through the upper opening 14.

In particular, when the upper opening 14 is opened by detaching the lid 430 from the box body 11, an article is readily taken in and out through the upper opening 14. When the lid 430 coupled to the box body 11 is pivoted to open the upper opening 14, the lid 430 is located at a position relatively close to the upper opening 14. Thus, the lid 430 may prevent an article from being taken in and out. This is because, when the lid 430 is detached from the box body 11, the lid 430 is not located at a position relatively close to the upper opening 14.

Further, when the upper opening 14 is closed by the lid 430 with an article stored in the storage 20, the lid 430 holds the article in the stored state. In this manner, the console box 410 provides a general function of storing an article in the storage 20.

When the lid 430 is decoupled from the box body 11 so that the lid 430 is detached from the box body 11, the lid 430 detached from the box body 11 can be coupled to the door trim 480. This allows the function of the tray portion 481 of the lid 430 to be provided in the door trim 480, which is a vehicle interior component that is different from the console box 410.

(2) In the interior structure for the vehicle, the lid 430 includes the pivot shafts 54. The box body 11 and the door trim 480 each have the shims 70, which pivotally support the lid 430 on the pivot shafts 54.

In this configuration, the box body 11 and the door trim 480 have the shims 70, which respectively function as the shaft supports. Thus, the pivot shaft 54 of the lid 430 can be coupled to each shim 70 of the door trim 480 in the same manner as the manner in which the pivot shaft 54 of the lid 430 is coupled to each shim 70 of the box body 11. This allows the lid 430 detached from the box body 11 to be readily attached to the door trim 480.

Modifications

The vehicle interior structure for the vehicle of the above embodiment may be modified as follows. The above embodiment and the following modifications can be combined as long as the combined modifications remain technically consistent with each other.

The upper opening 14 may be formed in a rectangular shape that is longer in the left-right direction than in the front-rear direction. In addition, on condition that the shape is rectangular, the shape of the upper opening 14 may be changed to a shape that is different from that of the above embodiment. Further, the shape of the upper opening 14 may be changed to a shape that is different from the rectangular shape.

The two pivot shafts 54 may be extended in the left-right direction instead of the front-rear direction.

One of the two pivot shafts 54 may be omitted so that the lids 430 may each be changed to a single-door type lid. In this case, the lock mechanism 60 corresponding to the pivot shaft 54 that is subject to omission is omitted.

To pivotally couple each of the lid bodies 431 to the box body 11, the opposite ends of the pivot shaft 54 in the front-rear direction need to have a shaft shape extending in the front-rear direction. Thus, the entire pivot shaft 54 may have a shaft shape as a whole as in the above embodiment. An intermediate portion of the pivot shaft 54 in the front-rear direction does not need to have a shaft shape.

The lock mechanism 60 may lock the lid 430 with the upper opening 14 closed without using the shim 70.

For example, each pivot shaft 54 may be divided into two shafts in the front-rear direction. The two shafts include a first shaft having a columnar first end and a second shaft having a columnar second end. The first shaft and the second shaft are biased away from each other in the front-rear direction by a spring provided therebetween.

Each of the front and rear support walls 21 of the box body 11 includes a tubular bearing having a closed end, instead of the shim accommodating portion 22. The first end and the second end of each pivot shaft 54 are accommodated in a corresponding bearing. The first end and the second end are pivotally supported by each bearing.

Furthermore, an interlock mechanism is disposed between the operation portion 65 and the first and second shafts. The interlock mechanism moves the two shafts in a direction in which the two shafts move toward each other in the front-rear direction, in conjunction with the inward movement of the operation portion 65 in the left-right direction.

In this case, the first end and the second end can be removed from the bearing by pushing the operation portion 65 so that the pivot shaft 54 can be decoupled from the support wall 21 (the box body 11).

The lid 430 may be detachable from the box body 11 even when the two operation portions 65 are not simultaneously operated. For example, one of the operation portions 65 is operated to decouple the corresponding pivot shaft 54 from the support wall 21. After the decoupling, the other operation portion 65 is operated to decouple the corresponding pivot shaft 54 from the support wall 21. As a result, the two pivot shafts 54 are both decoupled from the support wall 21 so that the lid 430 becomes detachable.

The operation portion 65 is not limited to one that is operated to be pushed inward in the left-right direction, and may be of a tiltable lever type. In this case, the operation portion 65 may be located in the box body 11 instead of the lid body 431. A conversion mechanism is disposed between the operation portion 65 and the pivot shaft 54. When receiving a force that tilts the operation portion 65, the conversion mechanism converts the force into a force that moves the pivot shaft 54 inward in the left-right direction.

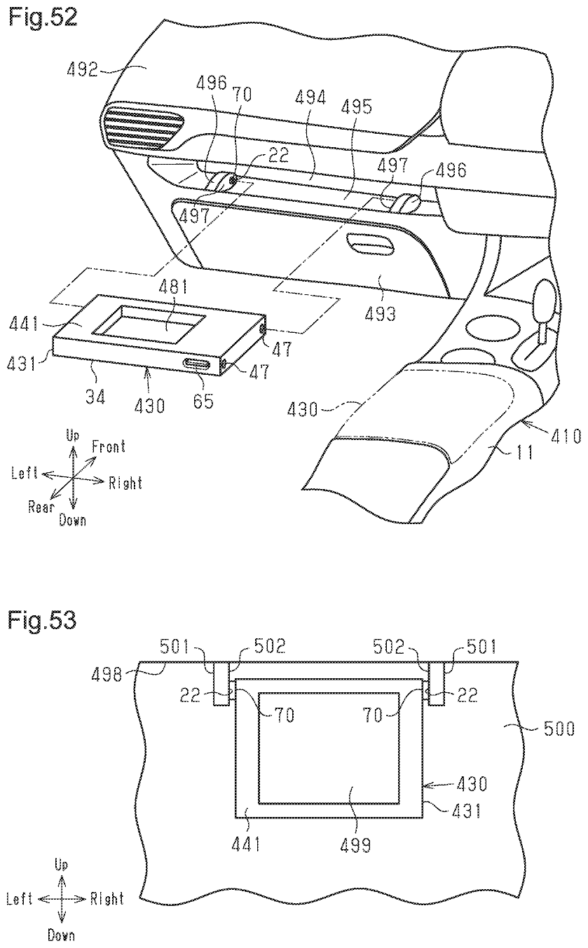

As shown in FIG. 52, the lid 430 detached from the box body 11 may be configured to be detachably coupled to an instrument panel 492 as an example of the vehicle interior component. Specifically, a panel recess 494 that is adjacent to a glove compartment 493 is disposed in a lower portion of the instrument panel 492 to open rearward. The panel recess 494 has a lower surface 495 that is a substantially horizontal surface extending in the left-right direction.

The lower surface 495 of the panel recess 494 has two lid supports 496 that are spaced apart from each other in the left-right direction. The region between the two lid supports 496 on the lower surface 495 of the panel recess 494 has a length in the left-right direction that is slightly longer than the length of the lid 430 in the long side direction, and has a length in the front-rear direction about one third of the length of the lid 430 in the short side direction. The two lid supports 496 respectively have flat inner surfaces 497 in the left-right direction facing each other in the left-right direction.

As shown in FIGS. 45 and 52, in the same manner as the box body 11, the inner surfaces 497 of the two lid supports 496 respectively include the shim accommodating portions 22 so as to face each other in the left-right direction. In the same manner as the box body 11, the shim 70 and the second spring 74 are coupled to each shim accommodating portion 22.

In the same manner as the box body 11, each shim 70 functions to detachably couple the end of one of the two pivot shafts 54 of the lid 430 to the instrument panel 492. That is, the instrument panel 492 includes the shims 70, which pivotally support the lid 430 at the pivot shaft 54. Thus, the lid 430 detached from the box body 11 is detachably coupled to the instrument panel 492.

This configuration allows the function of the tray portion 481 of the lid 430 to be provided not only on the box body 11 but also on the instrument panel 492, in the same manner as the case in which the lid 430 detached from the box body 11 is coupled to the door trim 480 for use.

As shown in FIG. 53, the lid 430 detached from the box body 11 may be configured to be detachably coupled to a roof lining 498 as an example of the vehicle interior component. The roof lining 498 is a member defining a ceiling in the passenger compartment. In this case, the second surface 441 of the lid 430 has a rectangular mirror 499 as an example of the function portion, instead of the tray portion 481.

Specifically, the front end of the roof lining 498 has two lid supports 501 that are located adjacent to a front windshield 500 and spaced apart from each other in the left-right direction. The distance between the two lid supports 501 is slightly larger than the length of the lid 430 in the long side direction. The two lid supports 501 respectively have flat inner surfaces 502 in the left-right direction facing each other in the left-right direction.

As shown in FIGS. 45 and 53, in the same manner as the box body 11, the inner surfaces 502 of the two lid supports 501 respectively include the shim accommodating portions 22 to face each other in the left-right direction. In the same manner as the box body 11, the shim 70 and the second spring 74 are coupled to each shim accommodating portion 22.

In the same manner as the box body 11, each shim 70 functions to detachably couple the end of one of the two pivot shafts 54 of the lid 430 to the roof lining 498. That is, the roof lining 498 includes the shims 70, which pivotally support the lid 430 at the pivot shaft 54. Thus, the lid 430 detached from the box body 11 is detachably coupled to the roof lining 498.

In this configuration, the coupling of the lid 430 to the two lid supports 501 of the roof lining 498 at one pivot shaft 54 to orient the second surface 441 rearward allows the lid 430 to function as a sun visor and allows the mirror 499 to be used as a vanity mirror.

The vehicle interior component may be a seat, a deck side trim, a pillar, or the like.

The tray portion 481 may function as an ashtray, for example.

The lid 430 may have a configuration in which the pivot shaft 54 is omitted and the lid 430 is coupled to a vehicle interior component that is different from the box body 11 and the console box 410 such that the lid 430 can be detached by, for example, sliding.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A console box, comprising:
a box body including a storage that has an upper opening; and
a lid detachably coupled to the box body and configured to open and close the upper opening,
wherein the lid includes an additional function portion that allows a user to use the lid in a manner that is different from the opening and closing of the upper opening.

2. The console box according to claim 1, wherein
the upper opening is opened when the lid is detached from the box body,
the lid includes a lid body and a leg disposed on one surface of the lid body in a thickness direction,
the additional function portion includes the leg, and
the leg is configured to be moved between a use position at which the leg is raised from the lid body and a fold position at which the leg is folded.

3. The console box according to claim 2, wherein a surface of the lid body where the leg is disposed has a storage recess that stores the leg when the leg is moved to the fold position.

4. The console box according to claim 2, wherein a surface of the lid body on a side opposite to the leg is made of a material softer than a material of a surface of the lid body where the leg is disposed.

5. The console box according to claim 1, wherein
the upper opening is opened when the lid is detached from the box body,
the lid includes a lid body and an attachment portion disposed on one surface of the lid body in a thickness direction,
the additional function portion includes the attachment portion, and
the attachment portion is configured such that a leg is attachable to and detachable from the attachment portion.

6. The console box according to claim 1, wherein
the storage is a first storage,
the console box further comprises:
a first lock mechanism configured to lock the lid in a state in which the upper opening is closed; and
an operation portion configured to unlock, when operated, the lid locked by the first lock mechanism, and
the lid includes:
a second storage having an opening in one of surfaces of the lid in a thickness direction; and
a lid member configured to open and close the opening, and
the additional function portion includes the second storage.

7. The console box according to claim 6, wherein the lid includes a second lock mechanism configured to lock the lid member in a state in which the opening is closed.

8. The console box according to claim 6, wherein
the lid includes:
a lid body;
two pivot shafts extending in a direction that is orthogonal to a width direction of the lid body on opposite side portions of the lid body in the width direction, the pivot shafts being configured to couple the lid body to the box body; and
two operation portions disposed in correspondence with the two pivot shafts as members of the first lock mechanism, the operation portions being configured to decouple the pivot shafts from the box body when operated, and the operation portions being independent from each other, and
the lid is configured to, when one of the two operation portions is operated, pivot about one of the pivot shafts that corresponds to an other one of the two operation portions that is not operated and is coupled to the box body.

9. The console box according to claim 6, wherein one of the surfaces of the lid is a covering.

10. The console box according to claim 6, further comprising a mirror disposed on a back surface of the lid member.

11. The console box according to claim 1, wherein
the upper opening is opened when the lid is detached from the box body,
the console box further comprises a battery accommodated in the lid, the battery being configured to be electrically connected to an electronic device to supply power to the electronic device,
the additional function portion includes the battery, and
the battery includes:
a power storage unit configured to store externally supplied power; and
a power transmission unit configured to transmit the power stored in the power storage unit to the electronic device.

12. The console box according to claim 11, wherein the power transmission unit is configured to transmit the power stored in the power storage unit to the electronic device through contactless power supply.

13. The console box according to claim 11, wherein the electronic device is incorporated in the lid.

14. An interior structure for a vehicle, the interior structure comprising:
a console box including a box body with a storage that has an upper opening and including a lid detachably coupled to the box body and configured to open and close the upper opening; and
a vehicle interior component configured to be detachably coupled to the lid that has been detached from the box body, the vehicle interior component being different from the console box,
wherein the lid includes a function portion that functions when the lid is coupled to the vehicle interior component.

15. The interior structure according to claim 14, wherein
the lid includes a pivot shaft, and
the box body and the vehicle interior component each include a shaft support that pivotally supports the lid at the pivot shaft.

16. The interior structure according to claim 14, wherein the vehicle interior component is a door trim.

17. The interior structure according to claim 14, wherein the vehicle interior component is an instrument panel.

18. The interior structure according to claim 14, wherein
the vehicle interior component is a roof lining in a passenger compartment, and
the function portion includes a mirror.
